(19) United States
(12) Patent Application Publication
(10) Pub. No.: US 2025/0112691 A1
(43) Pub. Date: Apr. 3, 2025

(54) INTER-SATELLITE LINK NETWORKING AND ROUTING FOR MULTIBEAM S-BAND LOW EARTH ORBIT WITH ANALOG FEEDER LINKS

(71) Applicant: Hughes Network Systems, LLC, Germantown, MD (US)

(72) Inventors: Lin-Nan Lee, Potomac, MD (US); Victor Liau, Gaithersburg, MD (US); Stanley Kay, Rockville, MD (US)

(21) Appl. No.: 18/602,525

(22) Filed: Mar. 12, 2024

Related U.S. Application Data
(60) Provisional application No. 63/587,350, filed on Oct. 2, 2023.

(51) Int. Cl. H04B 7/185; H04B 7/204

(52) U.S. Cl. CPC H04B 7/18584; H04B 7/18586; H04B 7/2041

(57) ABSTRACT

Techniques are described herein for non-terrestrial network (NTN) communications via one or more transparent-mode non-geosynchronous (NGSO) satellites. Embodiments extend a terrestrial wireless network (TWN), such as 5G NR, for use with the satellites. Analog feeder uplink and downlink waveforms are formatted to carry forward and return direct-to-device (DtD) signals over respective subchannel channels, and the subchannels can be assigned with time and frequency dimensions that are compatible with resource block assignments of the TWN protocols. Use of the analog subchannels and time-division multiplexing with beam-hopping facilitates satellite communication of the DtD signals effectively as an extension of the TWN. Embodiments also support communication of satellite control signals as part of the analog feeder uplink waveform, and inter-satellite link (ISL) routing and communication on-board the satellite.

### CROSS-REFERENCE TO RELATED APPLICATIONS

This application claims priority to U.S. Provisional Patent Application No. 63/587,350 filed Oct. 2, 2023, entitled “INTER-SATELLITE LINK NETWORKING AND ROUTING FOR MULTIBEAM S-BAND LOW EARTH ORBIT WITH ANALOG FEEDER LINKS,” the entire disclosure of which is hereby incorporated by reference, for all purposes, as if fully set forth herein.

### BACKGROUND

Wireless connectivity continues to evolve to meet demands for ubiquity, convenience, reliability, speed, responsiveness, and the like. For example, each new generation of cellular communication standards, such as the move from 4G/LTE (fourth generation long-term evolution) networks to 5G (fifth generation) networks, has provided a huge leap in capabilities along with new and increasing demands on the infrastructures that enable those networks to operate. For example, 5G supports innovations, such as millimeter-wave frequencies, massive MIMO (Multiple Input Multiple Output), and network slicing, which enhance connectivity for unprecedented numbers of devices and data-intensive applications.

More recently, innovations in 5G networking (and its successors) have expanded from terrestrial-based communication infrastructures to so-called non-terrestrial network (NTN) infrastructures. NTN infrastructures leverage satellites and high-altitude platforms to extend 5G coverage and capabilities, such as to serve remote and otherwise underserved areas. Effective deployment of NTN solutions can help support connectivity and applications for rural users, emergency responders, global Internet-of-Things (IoT) deployments, etc.

However, non-terrestrial communication carry complexities and design concerns that are not present in terrestrial-based communications, which can add significant technical hurdles to NTN deployments. For example, effective ground-to-satellite communications involves accounting for orbital dynamics, handovers and/or other transitions between satellites, path loss, propagation delay, atmospheric conditions, inter-satellite and/or inter-beam interference, spectrum and regulatory considerations, and other considerations. New approaches continue to be developed to find technical solutions for overcoming, or at least mitigating, these and other technical hurdles.

### SUMMARY

Embodiments include systems and methods for non-terrestrial network (NTN) communications via one or more transparent-mode non-geosynchronous (NGSO) satellites. Embodiments extend a terrestrial wireless network (TWN), such as 5G NR, for use with the satellites. Analog feeder uplink and downlink waveforms are formatted to carry forward and return direct-to-device (DtD) signals over respective subchannels, and the subchannels can be assigned with time and frequency dimensions that are compatible with resource block assignments of the TWN protocols. Use of the analog subchannels and time-division multiplexing with beam-hopping facilitates satellite communication of the DtD signals effectively as an extension of the TWN. Embodiments also support communication of satellite control signals as part of the analog feeder uplink waveform, and inter-satellite link (ISL) routing and communication on-board the satellite.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an illustrative non-terrestrial network (NTN) communication system as a context for embodiments described herein.

FIG. 2 shows a block diagram of a first illustrative on-board signal handling architecture, according to some embodiments described herein.

FIG. 3 shows a block diagram of a second illustrative on-board signal handling architecture that supports inter-satellite links (ISLs), according to some embodiments described herein.

FIGS. 4A and 4B show two illustrative feeder-link frequency plans for use with transparent satellite-based NTN infrastructures, according to embodiments described herein.

FIG. 5 shows a simplified circuit block diagram of an illustrative implementation of a feeder-link receiver (FL Rx).

FIG. 6 shows a simplified circuit block diagram of an illustrative implementation of a feeder-link transmitter (FL Tx).

FIG. 7 shows a flow diagram of an illustrative method for non-terrestrial network communications via a non-geosynchronous orbit (NGSO) satellite, according to various embodiments described herein.

FIG. 8 shows an example configuration of an NTN communication system that provides global coverage using transparent satellites with ISLs, according to some embodiments described herein.

FIG. 9 shows an illustrative constellation (or portion of a constellation) of NGSO satellites traversing a same orbital path in an orbital plane.

FIG. 10 shows a flow diagram of a method for on-board routing in a NGSO satellite of a satellite constellation with analog feeder links, according to embodiments described herein.

### DETAILED DESCRIPTION

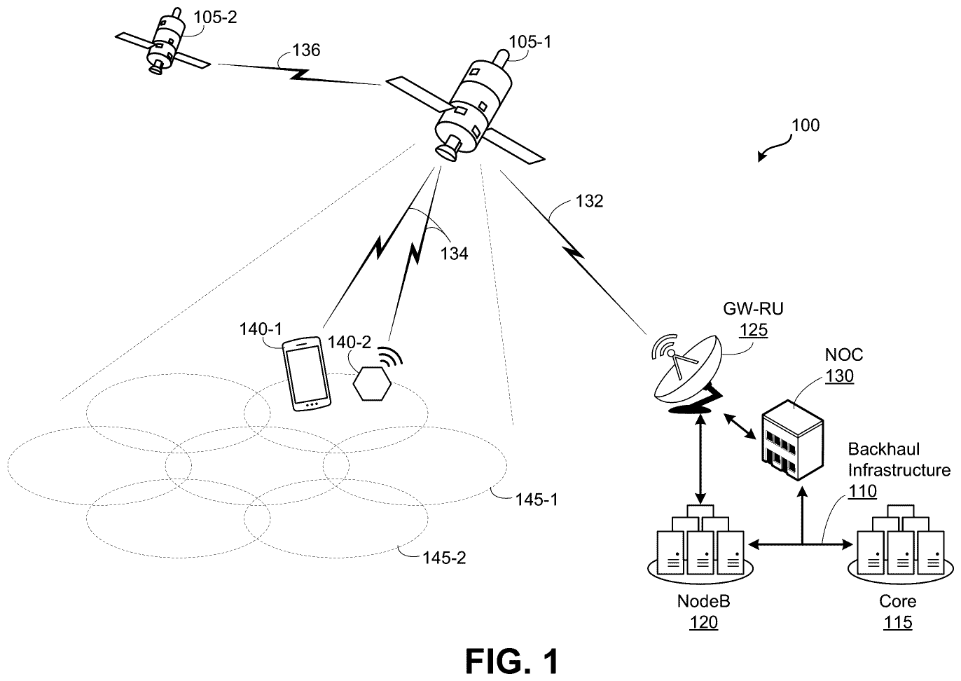

FIG. 1 shows an illustrative non-terrestrial network (NTN) communication system 100 as a context for embodiments described herein. The NTN communication system 100 generally provides wireless connectivity to a large number of user terminals 140 via an NTN architecture that enables extension of a next-generation terrestrial wireless (e.g., cellular) network via one or more satellites 105 (e.g., a constellation of satellites 105). The NTN communication system 100 facilitates direct-to-device (DtD) communications over satellite(s) 105 to the user terminals 140 based on next-generation cellular waveforms and protocols.

As illustrated, embodiments of the terrestrial wireless network (TWN) include a core network 115 and a NodeB 120 in communication via a backhaul infrastructure 110. Embodiments are implemented in the context of 5G new radio (NR) networks, and their related waveforms, protocols components, etc. For example, the core network 115 is described as a 5G core network (5GC), and the NodeB 120 is described as a next-generation NodeB (gNB). These descriptions are intended for added clarity, and not to limit the implementation of embodiments only to the 5G NR context. Indeed, techniques described herein can be modified to accommodate other (e.g., subsequent) versions and generations of architectures, such as fourth generation (4G) long-term evolution (LTE), sixth generation (6G), seventh generation (7G), etc. The terms “5G” and “5G NR” are used interchangeably herein.

As noted above, the core network 115 can be implemented as a 5GC. The core network 115 generally includes critical network and management functions. For example, the core network 115 can include an access and mobility management function (AMF) to manage the mobility of user devices, including registration, session management, mobility anchoring, and the like; a session management function (SMF) to handle session establishment, session modification, session termination, IP address assignment, QoS parameters, and the like; a user plane function (UPF) to handle packet routing, packet forwarding, traffic optimization, and the like; an authentication server function (AUSF) to handle user authentication and authorization; a user data management (UDM) function to handle subscriber data, subscription information, authentication credentials, policy rules, and the like; a network slice selection function (NSSF) to handle slice creation, slice destruction, slice customization, and the like; and/or other functions. The various components of the core network 115 can be implemented as physical devices and/or as virtualized network functions.

As noted above, the NodeB 120 can be implemented as a gNB (evolved from the enhanced NodeB (eNB) of 4G/LTE networks). Embodiments of the NodeB 120 can provide an interface between satellite gateways and the core network 115 to manage radio resource and facilitate connections between user devices 140 and the core network 115. In the illustrated NTN context, the satellite gateways are implemented as gateway radio units (GW-RUs) 125. The interface between the NodeB 120 and the core network 115 can be implemented as a “next-generation” (NG) interface that implements protocols, such as the Next-Generation Radio Access Network (RAN) Application Part (NGAP) protocol. Embodiments of the NodeB 120 can facilitate the packet data convergence protocol (PDCP) to handle header compression and encryption/decryption of user data packets; a radio link control (RLC) to handle segmentation, reassembly, and error correction of data packets between the NodeB 120 and user devices 140; medium access control (MAC) to schedule and prioritize data transmissions between the NodeB 120 and user devices 140 (e.g., to optimize radio resources); physical (PHY) layer functions, including modulation, coding, and transmission of radio signals; and other functions.

Embodiments of the NodeB 120 further include components referred to as one or more radio units (RU), central units (CU), and distributed units (DU). The RU generally handles PHY layer functions, such as radio signal transmission and reception. For example, the RU can convert digital streams into analog streams, which it can then modulate and encode for communication as RF signals via the GW-RUs 125; and/or the RU can convert analog streams from the GW-RUs 125 into digital streams, which it can then demodulate and decode for communication to the core network 115. The CU generally handles control plane functions, such as scheduling, handovers, radio resource management, etc. Typically, the CU facilitates centralized control and coordination of multiple RUs, connects with multiple DUs to coordinate and optimize radio resources, and interfaces with core network 115 functions (e.g., via the NG interface). The DU generally handles distributed processing of baseband functions, including baseband processing tasks related to the PHY layer (e.g., modulation and coding) and the MAC layer (e.g., scheduling and prioritization of user data in the time and frequency domains), and implementation of RLC and PDCP processing tasks.

Though not explicitly shown, the backhaul infrastructure 110 can include additional components and/or functions. Embodiments of the backhaul infrastructure 110 can include a transport network (e.g., fiber optics, terrestrial microwave, etc.) to facilitate high-speed, high-throughput, high-reliability communications between the NodeBs 120 and the core network 115. Some embodiments of the backhaul infrastructure 110 also include connections between NodeBs 120 (e.g., so-called “Xn” interfaces) to facilitate handovers, or the like. Some embodiments of the backhaul infrastructure 110 include fronthaul interfaces to facilitate coordination and communication between components of the NodeB 120 when implemented with distributed or split architectures. For example, the fronthaul interface can enable communications between distributed CUs and DUs. Embodiments of the backhaul infrastructure 110 can further include components to implement synchronization (e.g., to coordinate between NodeBs 120), security protocols, network segmentation and/or isolation, network orchestration (e.g., an operations support system (OSS)), end-to-end business functions (e.g., a business support system (BSS)), virtualization functions (e.g., for software-defined networking, network function virtualization, etc.), and/or other functions.

As described herein, the NTN communication system 100 expands the terrestrial wireless network (TWN) provide DtD communications with user devices 140 via satellite links. The satellite(s) 105 described herein are non-geosynchronous orbit (NGSO) satellites that do not perform any waveform processing on board (i.e., they are “non-processing” satellites) and use beamforming and beam-hopping to service the user terminals 140. As used herein, phrases like “non-processing satellite,” “do not perform any waveform processing on board,” and the like mean that the satellite does not perform any processing relating to modulation, coding, and/or other wireless-waveform-specific signal processing, except for frequency conversion, amplification, routing, and analog-to-digital or digital-to-analog conversion. In general, geostationary Earth orbit (GEO) satellites remain stationary over a fixed point on the Earth. In contrast, NGSO satellites orbit the Earth, so that their position above the Earth is constantly changing according to an orbital path. The orbital path can be inclined or polar. The orbital path is considered to be “polar” if it falls in an orbital plane that is nearly perpendicular to the equator, and the orbital path is considered to be “inclined” otherwise. For example, satellites following polar orbital paths tend to travel primarily in north-south directions, and satellites following inclined polar orbital paths tend to travel primarily in east-west directions. Embodiments described herein are applicable to NGSO satellite(s) 105 in both polar and inclined orbits.

The NGSO satellite(s) 105 can operate at low Earth orbit (LEO) or medium Earth orbit (MEO). LEO altitudes typically range from approximately 180 and 2,000 kilometers, and MEO altitudes typically range from approximately 2,000 to 35,786 kilometers. In some implementations, LEO satellite(s) 105 operate at orbital altitudes of approximately 500 to 1,400 kilometers. To achieve larger capacity, embodiments of the NGSO satellites 105 are implemented with large direct radiating antennas (DRAs), which can form dozens, or up to hundreds, of beams corresponding to cells 145 on the ground. Each DRA distributes the total power it transmits among a subset of these beams during each transmission interval. For example, a larger DRA can produce more power, which can support a larger number of beams for illuminating a larger number of cells 145 and can facilitate more frequency reuse.

The NGSO satellite(s) 105 can communicate with one or more GW-RUs 125 via one or more feeder links 132. Although only one GW-RU 125 is shown, it is assumed that the NTN communication system 100 includes a large number of geographically distributed GW-RUs 125. As an NGSO satellite 105 tracks across the surface of the Earth along its orbital path, it will successively move into and out of line-of-sight (LoS) with respect to different ones of the GW-RUs 125. For example, in a first timeframe, an antenna of a first GW-RU 125 can see the NGSO satellite 105; in a second timeframe, the antenna of the first GW-RU 125 can no longer see the NGSO satellite 105, but the antenna of a second GW-RU 125 can see the NGSO satellite 105. As such, maintaining communication between the GW-RUs 125 and the NGSO satellite 105 can involve relatively frequent feeder-link handoffs, handovers, and/or other types of transitions.

Each GW-RU 125 is a ground-based facility that serves as an interface between the NGSO satellite(s) 105 and a terrestrial wireless network (including the NodeB 120, the core network 115, and the backhaul infrastructure 110). Each GW-RU 125 includes an antenna designed to track the NGSO satellites 105 as they traverse their orbital paths. To facilitate such tracking, each GW-RU 125 can include electromechanical tracking components, processors to implement tracking and compensation algorithms, and/or other suitable components. The antennas can operate in any suitable satellite frequency band to support feeder-link communications, such as in the Ka-band or Ku-band. In some implementations, each feeder link 132 operates in the Ka-band frequency range of approximately 26.5 gigahertz (GHz) to 40 GHz. In one implementation, the uplink portion of the feeder link 132 (i.e., Earth-to-space) is in the range of approximately 24.75 to 25.25 GHz (or 27.5 to 28.6 GHz, or 29.1 to 30.0 GHz), and the downlink portion of the feeder link 132 (i.e., space-to-Earth) is in the range of approximately 18.8 to 20.2 GHz. Other embodiments can use other bands, such as the Q-band (33 to 50 GHz), the V-band (40 to 75 GHz), and/or the E-band (60 to 90 GHz).

Each GW-RU 125 can further include any suitable radiofrequency (RF) equipment for transmission and reception over the feeder link(s) 132, such as RF transceivers, amplifiers, demodulators, filters, etc. Each GW-RU 125 can further include any suitable equipment for interfacing with the TWN, such as signal processing equipment (e.g., modems) for converting data streams between those suitable for the feeder link(s) 132 and those suitable for the TWN infrastructure, network interface components (e.g., to support optical fiber, microwave, or other communication links), etc.

Embodiments of the NGSO satellites 105 also communicate with user terminals 140 via user links 134. As an NGSO satellite 105 moves, it can use beamforming to form beams that illuminate cells 145 on the ground, and each cell 145 has a respective cell coverage area. The term “respective” is used herein to denote a correspondence. For example, the phrase “each cell 145 has a respective cell coverage area” means that “cell A” corresponds to “cell coverage area A,” “cell B” corresponds to “cell coverage area B,” etc.; and that “cell A” is different from “cell B,” and “cell coverage area A” is different from “cell coverage area B.” Any user devices 140 in the cell coverage area of one of the illuminated cells 145 is potentially able to establish communications with the NGSO satellite 105 via a corresponding user link 134. The user links can use any suitable portion of the electromagnetic spectrum. Some embodiments of the user links 134 operate in the S-band, which encompasses frequencies ranging from approximately 2 to 4 GHz. In one implementation, the uplink portion of the user link 134 (i.e., Earth-to-space) is in the range of approximately 1,980 to 2,025 MHz, and the downlink portion of the user link 134 (i.e., space-to-Earth) is in the range of approximately 2,126 to 2,200 MHz. The S-band tends to be well-suited for mobile satellite services (MSS), such as communications between mobile devices and satellites for various reasons, such as the ability to use antenna sizes that are reasonable and practical for such applications, the tendency of S-band to provide relatively good atmospheric penetration, etc. Other embodiments can use other suitable frequency ranges below 6 GHz for the user links 134.

FIG. 1 depicts the user devices 140 as a smartphone (140-1) and an Internet-of-things (IoT) device (140-2). Embodiments can concurrently support communications with very large numbers (e.g., millions) of user devices 140, and the user devices 140 can include any suitable types of user devices 140. For example, the user devices 140 can include smartphones, satellite phones and other personal communicator devices, satellite radios, satellite television receivers, global positioning system (GPS) receivers, IoT asset and/or wildlife tracking tags, IoT environmental and/or other sensors, scientific research instruments, etc.

In general, communications from the TWN to the user devices 140 are referred to as “forward-link” communications, and communications from the user devices 140 to the TWN are referred to as “return-link” communications. For example, a forward-link communication passes from a GW-RU 125 to an NGSO satellite 105 via an uplink portion of the feeder link 132 and back down to a user device 140 via a downlink portion of the user link 134. A return-link communication passes from a user device 140 to the NGSO satellite 105 via an uplink portion of the user link 134 and back down to the GW-RU 125 via a downlink portion of the feeder link 132.

Embodiments of the NTN communication system 100 include a constellation of NGSO satellites 105. Such a constellation can include a large number of NGSO satellites 105 in one or more orbital planes, with one or more inclination angles, at one or more orbital altitudes, etc. As one example, the constellation can include 40 orbital planes with 25 NGSO satellites 105 in each orbital plane. Other examples of constellations can include thousands of NGSO satellites 105 in tens of planes to effectively provide continuous coverage of almost the entire surface of the Earth. Embodiments of the NGSO satellites 105 can communicate with adjacent ones of the NGSO satellites 105 in the constellation using inter-satellite links (ISLs) 136. For example, suppose NGSO satellite 105-1 is currently in communication with a GW-RU 125, but an adjacent NGSO satellite 105-2 is not in currently in communication with any GW-RUs 125 (e.g., it is currently over the ocean, in a geographic location without a GW-RU 125, over a GW-RU 125 that is not functioning, etc. NGSO satellite 105-2 may be able to communicate with the TWN via NGSO satellite 105-1 by using an ISL link 136.

Typically, ISLs 136 are implemented as digital RF or optical links. In some cases, an ISL can be implemented as an analog RF link. Embodiments described herein can operate with any of these, or any other suitable type of ISL 136. In some embodiments, one or more of the NGSO satellites 105 in a constellation can be implemented with two ISLs 136, one to communicate with the adjacent NGSO 105 ahead of it in the same orbital plane, and another to communicate with the adjacent NGSO 105 behind it in the same orbital plane (i.e., two inter-plane ISLs). In some embodiments, one or more of the NGSO satellites 105 in a constellation can be implemented with one or two ISLs 136 to communicate with adjacent NGSO satellites 105 in one or both adjacent orbital planes (i.e., intra-plane ISLs). Using the ISLs 136, the NGSO satellites 105 can effectively form a mesh network. In some embodiments, almost full global coverage can be continuously achieved with a maximum of two hops using both inter-plane and intra-plane ISLs. In other embodiments, almost full global coverage can be continuously achieved with a maximum of three hops using only intra-plane ISLs.

As noted above, the NTN communication system 100 seeks to provide DtD communications to user devices 140 by extending terrestrial wireless network (TWN) infrastructures (e.g., including associated waveforms, protocols, and the like) to accommodate satellite characteristics, such as Doppler and propagation delay. It is generally assumed herein that the user devices 140 are designed, in accordance with the TWN infrastructure, to communicate using TWN waveforms and protocols. In typical terrestrial-only (e.g., cellular) wireless communication infrastructures, user devices 140 typically communicate with terrestrial antennas (e.g., cell towers) in communication with terrestrial NodeBs that handle waveform processing.

When extending such an infrastructure to accommodate satellite links, there are essentially three categories of options for how to perform the waveform processing: completely on-board the satellite, partially on-board the satellite and partially on the ground, or completely on the ground. Typical conventional approaches tend to use on-board satellite processing capabilities of satellites to move some or all of the waveform processing (i.e., to move some or all of the NodeB functions) to the satellite. For example, the Third Generation Partnership Project (3GPP) Release 17 standards specify an NTN NR architecture in a so-called “transparent mode,” whereby waveform processing is performed on the ground for feeder-link (i.e., ground-to-satellite) communications, and no waveform processing is performed on-board the satellite for user-link (i.e., user device-to-satellite) communications. No specific feeder-link design is discussed there, although it can generally be assumed that: the waveform may be digitized and transmitted with digital modulation and coding based on common satellite-related standards, such as DVB-S2/S2X (e.g., because of their power efficiency and performance); and the analog waveform may be sent as it is for a single beam. For multi-beam satellites with dozens or even hundreds of beams, however, such options are incompatible with practical feeder-link bandwidth and throughput constraints.

Another category of approach is to move part of the 3GPP NR processing on-board the satellite. Adopting the general architecture for Node B used in terrestrial cellular networks, as discussed above, the waveform processing can be partitioned into RUs, DUs, and CUs. Some such approaches can move all or part of the RU function to the satellite, keeping the DU functions in the GW-RU, and the CU functions in a more centralized ground network. In such an approach, RU-to-DU communications can follow the cellular network practice of using enhanced common public radio interface (eCPRI) fronthaul protocols. The eCPRI protocols provide several options for splitting between on-board 5G NR functions and gateway functions. In such an approach, the physical layer of the feeder-link would typically be digital and formatted as a DVB-S2/S2X waveform. While such an approach can be effective, even moving only the RU functions to the satellite can add appreciable power requirements, complexity, etc. to the satellite.

Embodiments herein perform all waveform processing in a ground-based NodeB 120, as illustrated in FIG. 1. Because the NGSO satellites 105 are implemented herein as non-processing satellites, the waveform sent down from an NGSO satellite 105 to the user devices 140 is substantially the same as when that waveform was sent from the GW-RU 125 to the NGSO satellite 105. Thus, the NodeB 120 is configured essentially to consider the entire path from the GW-RUs 125 to the user devices 140 as transparent and to perform waveform processing accordingly.

As one example embodiment, the user devices 140 are configured to communicate over the S-band in accordance with 5G NR waveforms and protocols. In such an embodiment, a signal received by a user device 140 from an NGSO satellite 105 is an orthogonal frequency-division-multiplexed (OFDM) signal encoding digital information in an analog waveform. Architecting the NTN communication system 100 so that the NGSO satellite 105 relaying this signal does not perform waveform processing on the signal involves making sure that the signal sent up to the NGSO satellite 105 is the same OFDM signal encoding the same digital information in the same analog waveform. As such, embodiments of the ground-based NodeB 120 are tasked with generating this waveform. In the TWN, a 5G digital signal is received by the NodeB 120 (a gNB in the 5G case) from the 5G core network 115. The NodeB 120 applies modulation and coding schema to convert the digital information and error corrected bits into complex (I, Q) symbols representing the modulation type (e.g., quadrature phase shift keying (QPSK), 16-amplitude phase shift keying (16APSK), etc.). At this stage, the signal is still a digital signal, but the encoding is different from the original information bits. The NodeB 120 can then run the digital symbols through digital-to-analog (D/A) converters, which converts the signal to an analog signal representing the digitally encoded information. Embodiments of the NodeB 120 can then send the signal to an appropriate GW-RU 125. The GW-RU 125 can frequency-convert (e.g., up-convert) the analog signal to an appropriate satellite feeder-link frequency, such as to a carrier frequency in the Ka-band. The GW-RU 125 can then send the analog feeder-link signal (i.e., the forward uplink signal) to the NGSO satellite 105.

In some embodiments, waveform processing, routing, and other functions are assisted by a network operations center (NOC) 130. As illustrated, the NOC 130 can be coupled with the backhaul infrastructure 110 and/or other terrestrial network components, as needed (e.g., with NodeBs 120, GW-RUs 125, etc.). In general, the NOC 130 continually monitors network performance to ensure availability and security, including detecting and resolving incidents, optimizing network performance, addressing configuration issues, etc. Typically, the NOC 130 is also responsible for routine maintenance, disaster recovery planning, coordination with vendors and stakeholders, intrusion detection, firewalls implementation, network upgrades, and many other functions. In the context of some embodiments described herein, ISL communications can be used to support ocean coverage, to respond to GW-RU 125 failures, to allocate capacity, and/or to perform other ISL-enabled functions; and the NOC 130 can be fully or partially responsible for implementing those functions. For example, when a GW-RU 125 fails, causing a first NGSO satellite 105 to lose its feeder link, the NOC 130 can help determine how to exploit the feeder links of one or mor other NGSO satellites 105 in the constellation, along with associated ISL links, to maintain connectivity through the first NGSO satellite 105.

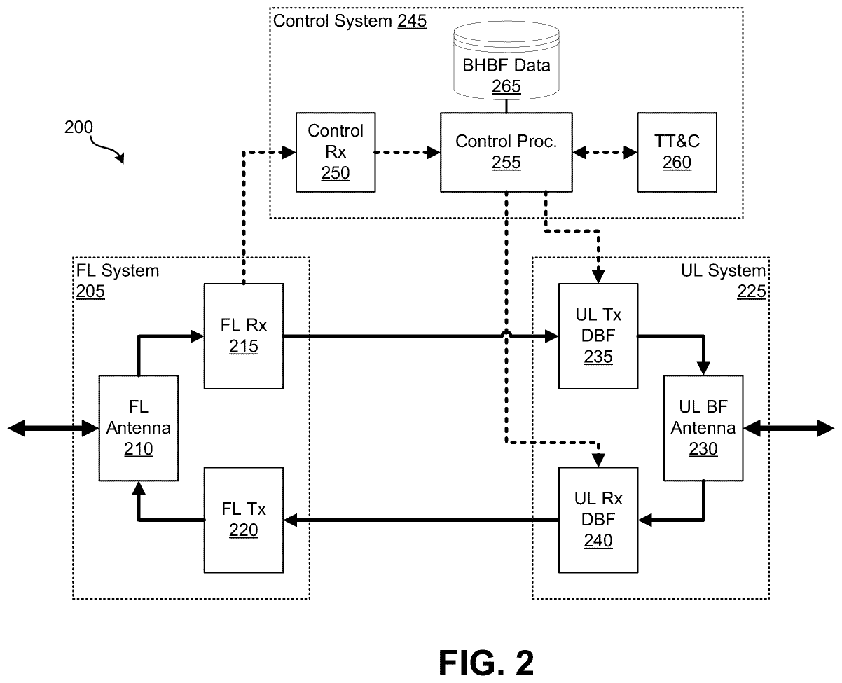

Implementing such an NTN communication system 100 with all waveform processing on the ground can involve a novel architecture for the NGSO satellite(s) 105. FIG. 2 shows a block diagram of a first illustrative on-board signal handling architecture 200, according to some embodiments described herein. The architecture 200 can be implemented in one or more (e.g., or all) of the NGSO satellite(s) 105 of the NTN communication system 100 of FIG. 1. As illustrated, the architecture 200 includes a feeder link (FL) system 205, a user link (UL) system 225, and a control system 245.

Embodiments of the FL system 205 include a FL receiver (Rx) 215 to receive forward uplink signals from a currently active GW-RU (e.g., GW-RU 125 of FIG. 1) via a FL antenna 210. Embodiments of the FL Rx 215 can include any suitable components to facilitate conveying received signals from the FL antenna 210 to other components of the architecture 200. For example, the FL Rx 215 can include a low-noise amplifier (LNA), one or more downconverters (e.g., to convert to an intermediate frequency (IF) band, to a baseband frequency, or to any other suitable frequency), and one or more filters (e.g., for selecting desired frequency bands and rejecting unwanted signals or noise). In some embodiments, the output of FL Rx 215 is one or more streams of digital complex samples generated by one or more analog-to-digital converters (ADCs) of the FL Rx 215. Some embodiments can include additional components, such as monitoring systems to measure and monitor signal quality, equipment health, and/or other parameters.

Embodiments of the FL system 205 also include a FL transmitter (Tx) 220 to transmit return downlink signals to the currently active GW-RU 125 via the FL antenna 210. Embodiments of the FL Tx 220 can include any suitable components to facilitate conveying signals from upstream components of the architecture 200 to the FL antenna 210, such as one or more digital-to-analog converters (DACs) to convert one or more received digital sample streams into analog signals for transmission. For example, the FL Tx 220 can include an upconverter to convert return signals to an appropriate feeder-link frequency, a high-power amplifier (HPA) for amplifying the signals (e.g., to overcome atmospheric attenuation, path loss, etc.), one or more filters (e.g., to ensure that the transmitted signals are within allocated frequency bands), a modulator to modulate signals onto a desired carrier, etc.

In some embodiments, the FL system 205 further includes the FL antenna 210. In context of NGSO satellites 105, embodiments of the FL antenna 210 are designed to maintain seamless communication with the ground (i.e., with GW-RUs 125) as the NGSO satellites 105 traverses its orbital path. For example, the FL antenna 210 can perform beam steering to maintain pointing of a high-power beam in the direction of a currently active GW-RU 125. Such beam steering can be performed mechanically (e.g., using gimbals, etc.) or electronically (e.g., using a phased array antenna). Embodiments of the FL antenna 120 include radiating elements to emit and/or receive FL signals, tracking components to accurately determine the positions of GW-RUs 125 and to adjust beam directions accordingly, control components (e.g., for beamforming, tracking, etc.), and/or any other suitable components. In some implementations, the FL antenna 210 can include some or all of the components described as part of the FL Rx 215 and/or the FL Tx 220. For example, the FL antenna 210 can include one or more LNAs, HPAs, transceiver modules, filters, frequency converters, etc. Where the FL antenna 210 is a phased array antenna, embodiments can further include a beamforming network of phase shifters and amplifiers to dynamically control the phases and amplitudes of signals across the radiating elements to effectively shape and steer one or more antenna beams.

Although only one FL antenna 210 is shown, the FL antenna 210 can include multiple antennas. For example, as described above, the NGSO satellites 105 traverse an orbital path. As such, a particular NGSO satellite 105 will sequentially enter and leave line-of-sight regions of different GW-RUs 125 over time so that maintaining communications between the ground and the NGSO satellite 105 involves frequently handing the communications over from one GW-RU 125 to the next in sequence along the NGSO satellite's 105 path. In anticipation of such handovers, while one of the FL antennas 210 is in communication with a currently active GW-RU 125 (i.e., the one of the GW-RUs 125 currently communicating feeder-link signals with the NGSO satellite 105), one or more other FL antennas 210 can be initiating communications with a next GW-RU 125 to facilitate a smooth handover with minimal interruption or delay.

Embodiments of the UL system 225 include a UL Tx digital beamformer (DBF) 235 and a UL Rx DBF 240 in communication with a UL beamforming (BF) antenna 230. Embodiments of the UL Tx DBF 235 direct the UL BF antenna 230 to form a large number (e.g., 128) of forward user beams in accordance with beam-hopping beamforming (BHBF) schema and to transmit forward downlink signals to user devices 140 located in cell coverage areas serviced by the forward user beams. Similarly, embodiments of the UL Rx DBF 240 direct the UL BF antenna 230 to form a large number (e.g., 128) of return user beams in accordance with the BHBF schema and to receive return uplink signals from the user devices 140 located in cell coverage areas serviced by the return user beams.

Embodiments of the UL BF antenna 230 dynamically form and steer beams to communicate with user devices 140 on the ground. Each formed beam illuminates a corresponding beam coverage area. User devices 140 can be considered as being in particular cell coverage areas, and each cell coverage area can coincide with one or more beam coverage areas. In some embodiments, a cell coverage area corresponds to a substantially fixed geographic area of the Earth's surface. Although the positions of the NGSO satellites 105 are constantly changing with respect to any particular cell coverage area, proper coordination of beamforming, beam steering, beam-hopping, and the like can ensure that one or more beams (e.g., several beams) are illuminating the cell coverage area at all times to effectively provide seamless communications to user devices 140 in that cell coverage area. Such beamforming, beam steering, and beam-hopping are performed by the UL Tx DBF 235 and the UL Rx DBF 240 applying BHBF schema to the UL BF antenna 230. Embodiments of the UL BF antenna 230 are implemented as a phased array of radiating elements. Alternatively, the UL BF antenna 230 can be implemented using any suitable configuration capable of beamforming and beam-hopping, such as metamaterial-based antennas.

Embodiments of the UL Tx DBF 235 include digital signal processing (DSP) elements to apply specific phase shifts and weights (or only phase shifts) to the signals, and digital-to-analog converters (DACs) to convert those signals for sending to individual radiating elements within the antenna array, thereby concurrently forming multiple directional beams pointed and focused to particular spots on the Earth's surface. Similarly, embodiments of the UL Rx DBF 240 include DSP elements to dynamically adjust phase shifts and amplitudes, thereby adjusting the reception pattern of receiving antenna elements of the phased array to enhance the sensitivity of the UL BF antenna 230 in directions corresponding to return user beams. The particular patterns of phase shifts and weights applied to the transmit and receive elements of the UL BF antenna 230 by the UL Tx DBF 235 and the UL Rx DBF 240 are dictated by BHBF schema, as described more fully below.

Embodiments of the control system 245 include a control Rx 250, a control processor 255, and a telemetry tracking and control (TT&C) block 260. In some implementations, the TT&C block 260 communicates with a satellite control function on the ground to monitor signal quality measurements, and the like. For example, the satellite control function can be integrated with and/or in communication with the GW-RU 125. Although the link between the FL system 205 and the control system 245 is shown as one-directional (i.e., from the FL Rx 215 to the control Rx 250), some embodiments can include a feedback path from the control system 245 to the FL system 205 (e.g., to the FL Tx 220). Such a feedback path can be used by the TT&C block 260 to send signal quality measurements and/or other information to the ground-based satellite control function.

As described below, the FL system 205 receives both DtD signals and control signals. The DtD signals can be formatted based on terrestrial wireless waveforms and protocols, such as 5G NR signals; and the control signals can be formatted based on satellite feeder-link waveforms and protocols, such as DVB-S2/S2X signals. In some implementations, the control signals are modulated by a robust DVB-S2/S2X modulation and coding in so-called constant code modulation (CCM) mode. The control signals (represented in FIG. 2 as dashed lines) are received by the control Rx 250, which is configured to receive and demodulate the control signals in accordance with its waveform formatting and protocols. Embodiments of the control Rx 250 can interface with the FL Rx 215 to receive the control signals. In some implementations, the control Rx 250 receives the control signals from the FL Rx 215 after the signals are down-converted and/or demodulated (e.g., DVB-S2 signals are typically modulated using quadrature phase shift keying (QPSK), 8 phase shift keying (8PSK) or other sophisticated modulation schema). In other implementations, the control Rx 250 receives the control signals from the FL Rx 215 prior to down-conversion and/or demodulation, and the control Rx 250 down-converts and/or demodulates the control signals.

Embodiments of the control Rx 250 can then perform error correction (e.g., based on low-density parity-check (LDPC) and/or Bose-Chaudhuri-Hocquenghem (BCH) codes) to mitigate the impact of channel impairments and noise during transmission, thereby helping to ensure the integrity of the received control data. Some embodiments can perform other types of processing, such as transport stream processing to extract relevant components from the control signal. Embodiments of the control Rx 250 also decode the demodulated and error-corrected control signal, effectively converting the received control signal into a stream of digital control data.

The down-converted, demodulated, and processed digital control data can be passed to the control processor 255, which can use the digital control data to perform several functions. In some embodiments, the control Rx 250 does not perform any or all of the above processing, and some or all of the above processing is performed, instead, by the control processor 255 prior to performing other functions. One function of the control processor 255 is to use the digital control data to coordinate with the TT&C block 260. Embodiments of the TT&C block 260 generally handle telemetry, tracking, and command functions. Telemetry functions can include collection of real-time data from portions of the architecture 200 (e.g., and/or other components of the satellite) and communication of that data with the GW-RUs 125. The data can include measurements of temperature, power consumption, system voltages, and/or other parameters as indications of satellite health, status, and performance. Tracking functions can include coordination with ground-based tracking (e.g., at the GW-RUs 125), which seek to monitor precise locations and orientations of the satellites 105. In some cases, tracking functions can also include one satellite's tracking of one or more other adjacent satellites (e.g., in the same plane, in an adjacent plane, etc.) in the same constellation. The control processor 255 is primarily concerned with control functions of the TT&C block 260, which can include receiving control commands from a satellite control facility on the ground to direct performance of specific actions or adjustments at the satellite. For example, the control commands can be used to control the satellite's orientation, power distribution, onboard system configurations, orbital maneuvers, etc.

Another function of the control processor 255 is to use the digital control data to direct beamforming and beam-hopping by the UL Tx DBF 235 and the UL Rx DBF 240. As described above, the UL system 225 can form user beams based on BHBF schema. As used herein, a particular BHBF scheme defines a set of complex beamforming weights for each element which, when applied by the UL Tx DBF 235 and/or the UL Rx DBF 240 to signals going to and/or coming from radiating elements of the UL BF antenna 230, will result in a respective deterministic set of formed user beams of particular sizes, shapes, and locations on the ground (based on the current position and orientation of the satellite). In some embodiments, the control processor 255 computes the BHBF schema to direct beamforming and beam-hopping by the UL Tx DBF 235 and/or the UL Rx DBF 240. In such cases, the control data received by the control processor 255 can be used to perform the computations, such as by informing the control processor 255 of the present position and altitude of the satellite, the desired beam arrangement for the present time slot, etc.

In other embodiments, as illustrated, a large number of pre-computed BHBF schema are stored in a BHBF data store 265. For example, the BHBF schema can be stored as a lookup table, or in any other suitable manner. In such embodiments, the GW-RU 125 can dynamically perform beamforming computations to determine which of the pre-computed BHBF schema is most appropriate (e.g., is a best match) for any given satellite location and orientation, for any given time slot, etc. The GW-RU 125 can then use the control signal to send an identifier (e.g., an index) of the appropriate pre-computed BHBF schema to the satellite, and the control processor 255 can use the control signal to select the corresponding pre-computed BHBF schema from the BHBF data store 265. In some such embodiments, the GW-RU 125 can compute a forward-looking sequence of several pre-computed BHBF schema in accordance with the trajectory of the satellite, and/or other information; and the GW-RU 125 can send a sequence of corresponding identifiers to the satellite so that the control processor 255 can select appropriate pre-computed BHBF schema from the BHBF data store 265 in accordance with the sequence. In some embodiments, even when pre-computed BHBF schema are selected from the BHBF data store 265, the BHBF schema can be adjusted slightly (e.g., by the GW-RU 125 and communicated via the control signal, and/or by the control processor 255) to account for dynamic changes in signal quality, network requirements (e.g., surges in demand), etc.

In the forward direction, as shown in FIG. 2, the FL Rx 215 receives feeder uplink signals via the FL antenna 210, and the feeder uplink signals include DtD signals and control signals. The control signals are passed to the control system 245, as described above. The DtD signals can be passed through to the UL Tx DBF 235 for relay back down to user devices 140 as a user downlink signal via the UL BF antenna 230. No waveform processing is applied to the DtD signals, and the satellite acts essentially as a bent-pipe relay. In the return direction, the control signals perform the same functions as in the forward direction (i.e., directing the BHBF to form receive beams in the correct directions at the correct times). Return uplink signals (from user devices 140) are received by the UL Rx DBF 240 via the UL BF antenna 230 and are passed through to the FL Tx 220 for relay back down to a currently active GW-RU 125 via the Fl antenna 210.

The architecture 200 of FIG. 2 assumes that there are no ISL signals or ISL links. For example, there can still be a large number of NGSO satellites 105 operating as a constellation in communication with a large number of geographically distributed GW-RUs 125; but the NGSO satellites 105 are unable to communicate directly with each other. As described with reference to FIG. 1, some embodiments described herein implement NTN communication systems that rely on NGSO satellites 105 having inter-plane and/or intra-plane ISLs, such as for maintaining continuous nearly global coverage.

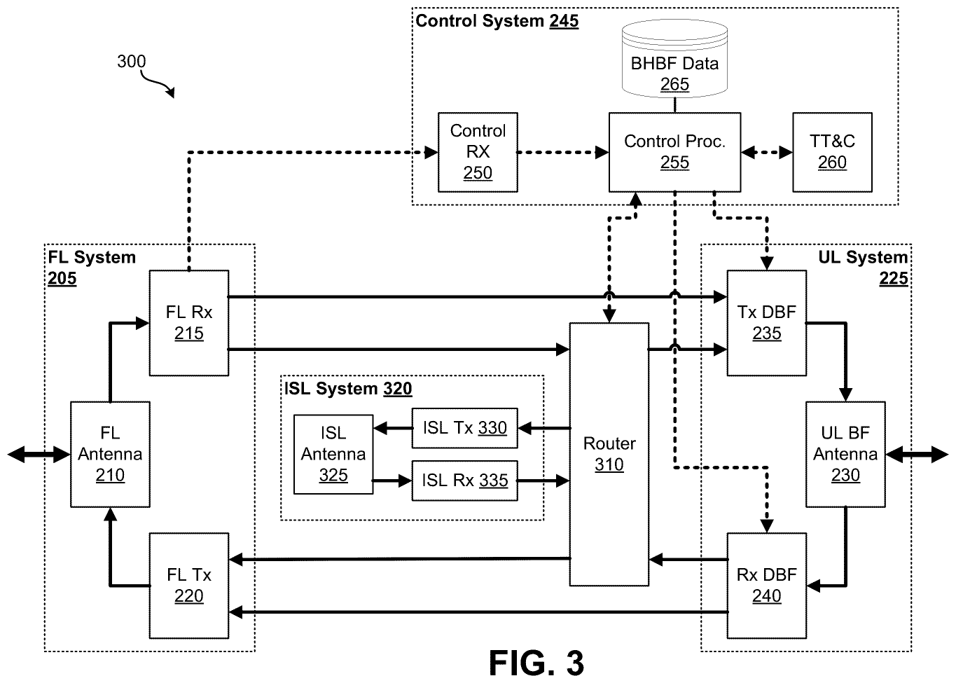

FIG. 3 shows a block diagram of a second illustrative on-board signal handling architecture 300 that supports inter-satellite links (ISLs), according to some embodiments described herein. The architecture 300 can be implemented in one or more (e.g., or all) of the NGSO satellite(s) 105 of the NTN communication system 100 of FIG. 1. As in FIG. 2, the architecture 300 includes a FL system 205, a UL system 225, and a control system 245. Except as otherwise described, the FL system 205, the UL system 225, and the control system 245 include the same components and operate in the same manner as described above with respect to FIG. 2. As illustrated, the architecture 300 of FIG. 3 additionally includes a router 310 and an ISL system 320.

Embodiments of the ISL system 320 include an ISL transmitter (Tx) 330 and an ISL receiver (Rx) 335. Some embodiments of the ISL system 320 also include one or more ISL antennas 325. The ISL system 320 generally handles communications over one or more ISLs (e.g., inter-plane and/or intra-plane ISLs links) with one or more adjacent satellites in a same constellation, and the ISL antenna(s) 325 can include any antennas suitable for that purpose. For example, the ISL antenna(s) 325 can include a phased array antenna, parabolic reflector, or other antenna type. ISL signals sent over the ISLs can be in any suitable frequency range, such as in a typical satellite RF band (e.g., Ka-Band) or an optical band (e.g., using laser beams).

The ISL signals can be modulated and/or encoded in any suitable manner. In some embodiments, the ISL signals encode bits using On-Off-Keying (on if ‘1’, off if ‘0’), or another digital encoding scheme, so that the ISL signals are considered digital signals. In such cases, the digital ISL signals can be converted from analog-to-digital signals (i.e., digitized) prior to transmission over an ISL, and/or they can be converted from digital-to-analog signals after reception over an ISL. In other embodiments, ISL signals can apply analog modulation to the waveform so that the ISL signals are considered analog signals. For example, data can be encoded onto an optical signal by modulating the intensity of a laser transmission. Embodiments of the ISL Tx 335 and the ISL Rx 340 are configured to perform some or all of the modulation, coding, and/or other processing (e.g., frequency conversion, filtering, amplifying, etc.) involved in converting signals into ISL signals for transmission and/or from ISL signal after receipt.

In general, the ISL signals carry data corresponding to a portion of the DtD signals. In some cases, because some of the ISL signals carry the same data as forward uplink waveforms received by the FL system 205, certain ISL signals may additionally carry data encoded in the control signals. In some implementations, control information is carried in-band as part of the ISL signal information (e.g., similar to the manner in which the control information is received on the feeder uplink waveform). In other implementations, the control information can be embedded in the ISL signal in packets, such as in header information, or in any other suitable manner. For example, such embedding may be used where the ISL signals are digitized prior to sending over the ISL link.

Embodiments of the router 310 include any suitable components to route signals between the FL system 205, the UL system 225, and the ISL system 320. For example, the router includes a switch fabric, a crossbar switch, a multistage interconnection network, a bus-based architecture, store-and-forward switching, output-buffered switching, time-division multiplexing (TDM), wavelength division multiplexing (WDM), packet switching, and/or any other suitable techniques. In some embodiments, the routing is in accordance with control data received from the control processor 255. For example, the control data is derived by the control processor 255 from received control signals.

Several scenarios can be considered. In a first scenario, the satellite receives a forward DtD signal from a currently active GW-RU 125 for relaying back down to one or more user devices 140 currently being served by user beams of the satellite. In this scenario, the FL Rx 215 receives the feeder uplink DtD signal via the FL antenna 210 and can pass the signal directly to the UL Tx DBF 235 for relay back down to user devices 140 as a user downlink signal via the UL BF antenna 230. In the illustrated architecture 300 of FIG. 3, the signal bypasses the router 310. In an alternative implementation, all signals are passed through the router 310. In such an alternative implementation, the FL Rx 215 receives the feeder uplink DtD signal via the FL antenna 210 and passes the signal to the router 310, which can forward the signal to the UL Tx DBF 235 for relay back down to user devices 140 as a user downlink signal via the UL BF antenna 230.

In a second scenario, the satellite receives a return DtD signal from one or more user devices 140 currently being served by user beams of the satellite for relaying back down to a currently active GW-RU 125. In this scenario, a return uplink DtD signal is received by the UL Rx DBF 240 via the UL BF antenna 230 and is passed directly to the FL Tx 220 for relay back down to a currently active GW-RU 125 via the FL antenna 210. In the alternative implementation described in the preceding paragraph, the return uplink DtD signal is received by the UL Rx DBF 240 via the UL BF antenna 230 and is passed to the router 310, which can forward the signal to the FL Tx 220 for relay back down to a currently active GW-RU 125 via the FL antenna 210.

In a third scenario, the satellite receives a control signal from a currently active GW-RU 125 on the forward uplink. In this scenario, the FL Rx 215 receives the control signal via the FL antenna 210 and can pass the signal directly to the control system 245.

In a fourth scenario, the satellite receives a forward DtD and/or control signal from a currently active GW-RU 125 for relaying through at least one hop via an ISL link to another satellite. In a fifth scenario, the satellite receives a return DtD signal from one or more currently served user devices 140 for relaying through at least one hop via an ISL link to another satellite. In these two scenarios, an analog signal is received (either the FL Rx 215 receives a feeder uplink signal via the FL antenna 210, or the UL Rx DBF 240 receives a user uplink signal via the UL BF antenna 230), and the analog signal is passed to the router 310. The router 310 routes the signal to the ISL Tx 330, which prepares the signal, as appropriate, for communication over the ISL and transmits the signal over the ISL via the ISL antenna 325. For example, in cases where the ISL is designed for digital ISL signals, the router 310 or the ISL Tx 330 can digitize the analog signal into a properly formatted digital ISL signal.

In a sixth scenario, the satellite receives an ISL signal from another satellite via the ISL link. In this scenario, the ISL Rx 335 receives the signal via the ISL antenna 325 and forwards the signal to the router 310. The router 310 can then determine (e.g., based on its own control data, or based on control data received via the ISL) an appropriate routing for the signal based on the signal's destination. If the received ISL signal is a forward signal destined for one or more user devices 140 currently being served by the receiving satellite, the router 310 can forward the signal to the UL Tx DBF 235 for sending down to user devices 140 as a user downlink signal via the UL BF antenna 230. If the received ISL signal is a return signal destined for the currently active GW-RU 125 of the receiving satellite, the router 310 can forward the signal to the FL Tx 202 for sending down to the GW-RU 125 as a feeder downlink signal via the FL antenna 210. In these two cases, the ISL Rx 335 and/or router 310 can convert the signal, as needed, for sending as an analog signal over the feeder or user downlink. For example, if the received ISL signal is a digital signal, the signal can be converted back to an analog signal prior to forwarding to the FL system 205 or the UL system 225. If the received ISL signal is a forward or return signal destined for another hop via another ISL to another satellite (i.e., a third satellite), the router 310 can forward the signal to the ISL Tx 330 for sending over another ISL via the same or a different ISL antenna 325.

As described herein, an NGSO satellite 105 designed according to the transparent architecture 300 of FIG. 3 can be part of a constellation of such satellites. As one example, a satellite constellation can include 200 satellites arranged in 25 orbital planes with 8 satellites in each orbital plane, each orbiting at an altitude of approximately 674 km. The constellation has a 54-degree inclination and uses optical intra-plane ISLs with up to three hops to provide nearly complete global coverage. For example, the constellation may communicate with 41 gateways (GW-RUs) that are geographically distributed around the globe, each designed for a minimum elevation angle of 15 degrees. In the illustrative constellation, each satellite is designed to have an antenna effective isotropic radiated power (AEIRP) of at least 64 dbW, an antenna gain-to-noise temperature ratio (G/T) of at least 9 dB/K, at least 1,000 Watts of radiated RF power, and a mass of approximately 750 to 1,000 kilograms. Each satellite has a digital beamforming phased array antenna capable of forming 128 active beams (at a time) at 5 MHz per beam. For example, each satellite can be responsible for illuminating thousands of cells in its satellite coverage area, but the satellite can only form 128 active beams at a time. As such, the BHBF schema define both beamforming and a beam-hopping schema. The beam-hopping schema facilitate time sharing (e.g., time-division multiplexing) of the satellite's bandwidth and power by hopping the active beams to different locations in the satellite coverage area in each of a sequence of time slots; so that over each iteration of the sequence of time slots, thousands of beam coverage areas within the satellite coverage area can be illuminated.

The various components of the architectures 200 and 300 illustrated in FIGS. 2 and 3 can be implemented in any suitable manner. In some implementations, one or more of the components is implemented as a circuit using discrete components. In some implementations, one or more of the components (e.g., the control processor 255, the router 310, etc.) are implemented using any suitable one or more processors. For example, such components can include a central processing unit CPU, an application-specific integrated circuit (ASIC), an application-specific instruction-set processor (ASIP), a digital signal processor (DSP), a field-programmable gate array (FPGA), a programmable logic device (PLD), a controller, a microcontroller unit, a reduced instruction set (RISC) processor, a complex instruction set processor (CISC), a microprocessor, or the like, or any combination thereof. In some implementations, one or more of the components is implemented by using one or more processors to execute processor-readable instructions stored on a non-transitory, processor-readable medium. Though not explicitly shown, the architectures 200 and 300 illustrated in FIGS. 2 and 3 can include any suitable non-transitory, processor-readable storage for storing such instructions.

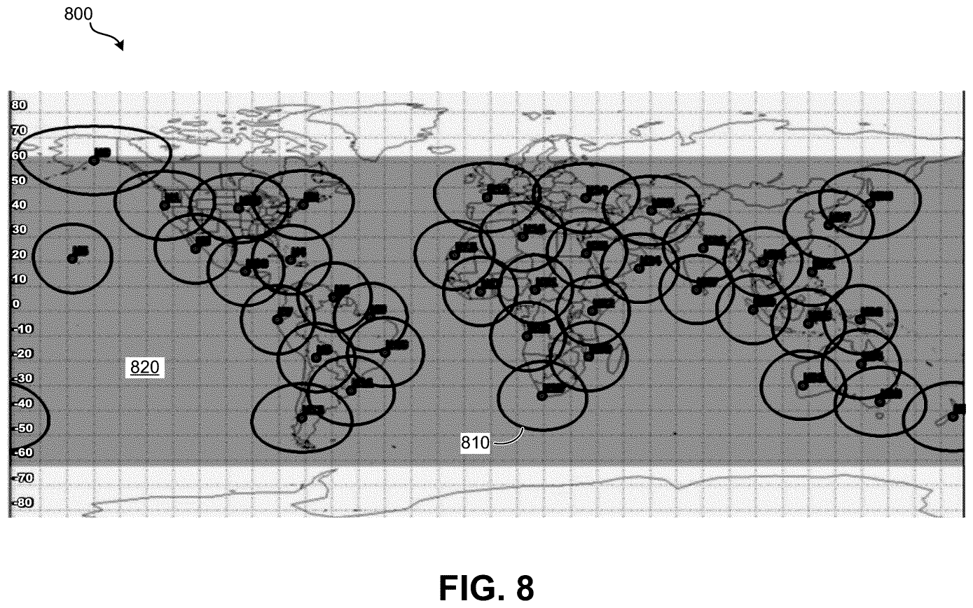

FIG. 8 shows an example configuration of an NTN communication system 800 that provides global coverage using transparent satellites with inter-satellite links (ISLs), according to some embodiments described herein. The system 800 can be an implementation of the NTN communication system 100 of FIG. 1 with the NGSO satellites 105 of the NTN communication system 100 configured according to the architecture 300 of FIG. 3, or any suitable modification thereof. To achieve global coverage can involve providing service when one or more satellites of the constellation is not over a GW-RU coverage area 810 and does not have a feeder-link connection. For example, it may be impractical (e.g., cost-prohibitive) to deploy a GW-RU in the middle of the ocean. Further, it can be desirable to ensure that global coverage is maintained even when one or more GW-RUs fails, such that one or more satellites loses its feeder-link connection. Both of these concerns can be addressed using ISLs. For example, for a satellite presently without a feeder-link connection, signals can be routed to the satellite via one or more other satellites in the constellation using ISLs. As described with reference to FIG. 1, such ISL-related features can be directed partially or completely by a NOC 130.

In the illustrated system 800, dark circles represent illustrative GW-RU coverage areas 810. In particular, forty-one geographically distributed GW-RUs are deployed, each with a minimum elevation angle (MEA) of 15 degrees. Such a configuration can provide global coverage without any service gaps between 64 degrees north and 64 degrees south latitude, assuming an MEA for all user terminals of 20 degrees. Allowing for a lower MEA can extend coverage up to 78 degrees latitude (e.g., to cover the northern portion of Alaska). As described below, this global coverage can be implemented with only intra-plane ISLs and up to three hops. As used herein, the phrase “global coverage” is not intended to mean that every inch of the globe is covered; rather, that substantially all populated regions on Earth are covered, assuming practical constraints on MEAs, antenna sizes, link budgets, transmit power, etc.

Conventionally, satellites that support ISLs have certain characteristics. First, such satellites conventionally tend to include on-board waveform processing to support ISL communications. ISLs are typically implemented as either digital RF or digital optical communication links, and routing of those signals can conventionally involve packet switching, and/or other digital routing protocol implementations. Although embodiments described herein use non-processing satellites, novel techniques enable embodiment to operate in either digital RF or digital optical contexts, as well as in other contexts, such as where ISL links use analog RF communications.

Second, conventional satellites that support ISLs tend to include four or more (e.g., six) ISLs to support both inter-plane and intra-plane ISLs. Such an extensive ISL framework allows constellations of such satellites to achieve global reach with only one or two hops. However, implementing inter-plane ISLs can involve additional ISL antennas, complex pointing and tracking components, complex routing protocols, and other features. For example, once initial acquisition is achieved, maintaining steady pointing of intra-plane ISLs tends to be relatively simple to achieve. In contrast, pointing of inter-plane ISLs often requires a fast slew-rate to follow rapid changes of the relative positions and directions of motion of the adjacent satellites, especially for inclined-orbit satellites. Routing traffic to take advantage of inter-plane ISLs for inclined-orbit satellites tends also to be very complicated and time-varying due to rapid changes in relative position and direction of motion of adjacent satellites in other planes. Some embodiments described herein implement only one or two inter-plane ISLs on each satellite. Such an approach can appreciably reduce and simplify the ISL implementation at the expense of a potential increase in latency due to additional hops.

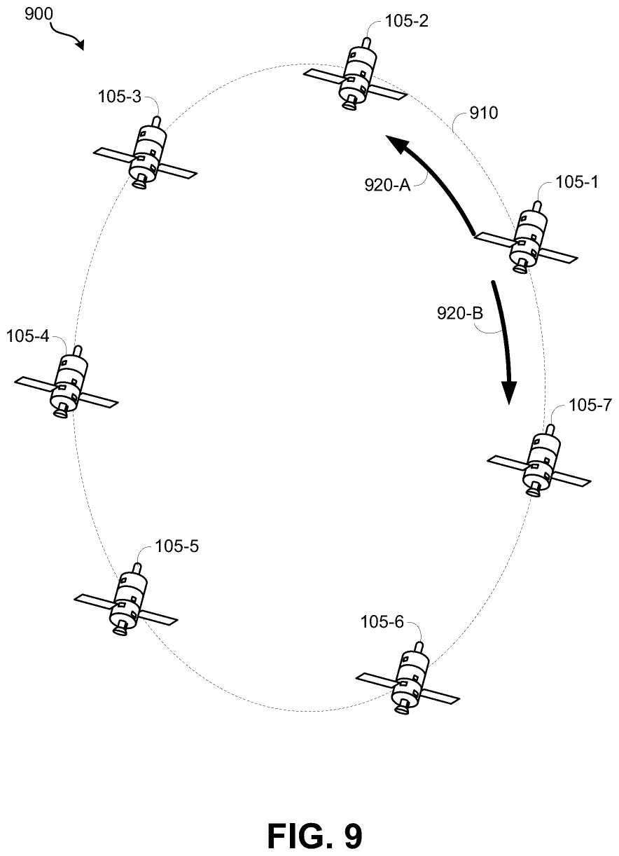

Embodiments of the system 800 assume a constellation of satellites (e.g., LEO satellites) arranged in an orbital plane, so that multiple satellite traverse a same orbital path in the orbital plane. For example, FIG. 9 shows an illustrative constellation 900 (or portion of a constellation) of NGSO satellites 105 traversing a same orbital path 910 in an orbital plane. As described herein, embodiments of the constellation 900 can be made up of non-processing (i.e., transparent) NGSO satellites 105. The illustrated constellation 900 includes seven NGSO satellites 105 that are approximately evenly spaced along the orbital path 910. The NGSO satellites 105 are configured to support at least one ISL according to the architecture 300 of FIG. 3. By virtue of the ISLs, the satellites of the constellation can effectively form a mesh network.

In some implementations, each NGSO satellite 105 includes two ISLs: one pointing to the NGSO satellite 105 directly ahead of it along the orbital path 910 (indicated by arrow 920-A), and another pointing to the NGSO satellite 105 directly behind it along the orbital path 910 (indicated by arrow 920-B). For example, if NGSO satellite 105-1 loses its feeder-link, it can receive communications using the feeder-link and the backward-looking ISL of NGSO satellite 105-2 via a single hop, or using the feeder-link and the forward-looking ISL of NGSO satellite 105-2 also via a single hop. In other implementations, each NGSO satellite 105 includes a single ISL: either one pointing to the NGSO satellite 105 directly ahead of it along the orbital path 910 (indicated by arrow 920-A), or one pointing to the NGSO satellite 105 directly behind it along the orbital path 910 (indicated by arrow 920-B). For example, if all of the NGSO satellites 105 only have a forward-looking ISL, and NGSO satellite 105-1 loses its feeder-link, it can receive communications using the feeder-link and the forward-looking ISL of NGSO satellite 105-7 via a single hop, but using the feeder-link and the forward-looking ISL of NGSO satellite 105-2 would involve six hops.

As described with reference to FIG. 3, each NGSO satellite 105 can receive analog forward signals (e.g., on subchannels of 5 MHz each) by its FL system 205. The received forward signals can be passed to the Tx DBF 235, or the forward signals can be digitized (e.g., by the router 310) and forwarded by the router 310 to the ISL system 320 for forwarding to one or more other satellites via one or more ISLs. Each NGSO satellite 105 can also receive analog return signals (e.g., also on subchannels of 5 MHz each) by its Rx DBF 240. The received return signals can be passed to the FL Tx 220 for transmission via the feeder downlink, of the return signals can be digitized (e.g., by the router 310) and forwarded by the router 310 to the ISL system 320 for forwarding to one or more other satellites via one or more ISLs. Additionally, digital ISL data can be received via one or more ISLs by the ISL system 320, and the received ISL data can be routed by the router 310 either to another satellite via the ISL system 320, to the FL Tx 220 for transmission via the return feeder downlink (e.g., after conversion to an analog subchannel signal), or to the Tx DBF 235 for transmission via a forward user downlink (e.g., after conversion to an analog subchannel signal).

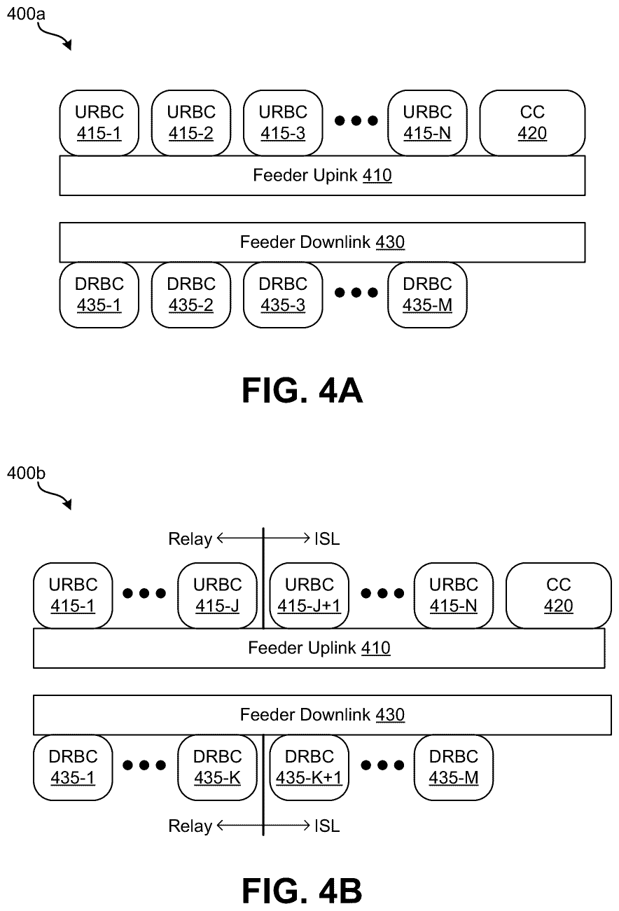

Control information can be received in-band, as a control channel 420 such as described with reference to FIG. 4 or embedded in digital packets received via the ISLs. The ISL capacity can be sized to accommodate at least one fully loaded feeder link in each direction. Such sizing can support outage of a GW-RU by supporting connecting the NGSO satellite 105 to another GW-RU via a different NGSO satellite 105 in the same orbital plane. Such sizing can also support aggregation of traffic for NGSO satellites 105 passing over the ocean, and/or other regions without GW-RU access. Embodiments can be implemented with one-way communication of control information. For example, the control information is only included in forward communications. A robust, constant coding modulation (CCM) can be used for the control information, such as defined by the DVB-S2X standard.

The control information can be used by the router 310 of an NGSO satellite 105 to determine whether a signal received by the router 310 is destined for that NGSO satellite 105 (i.e., for a feeder or user downlink from that NGSO satellite 105) or for another NGSO satellite 105 of the constellation via an ISL link. As noted above, the control information can be received by that NGSO satellite 105 from its FL system 205 (e.g., received by the router 310 via the control processor 255, as illustrated in FIG. 3), or from its ISL system 320 from another NGSO satellite 105. In some embodiments, digitizing the feeder-link signal for use by the router 310 (e.g., by the FL Rx 215 and/or by the router 310) includes attaching a destination tag based on control information received from the control processor 255 or the ISL system 320. The destination tag can indicate to the router whether to route the corresponding signal to a particular ISL.

Embodiments can implement the destination tag in several ways without relying on packet routing protocols, digital packet headers, or the like. Some embodiments implement the destination tag as a N-bit tag, where there are X NGSO satellites 105 in the orbital plane, and N is the closest integer greater than log₂ X. For example, where there are seven NGSO satellites 105 in the orbital plane, N=3. In some such embodiments, the N-bit tag can represent a digital index of the destination NGSO satellite 105 in the orbital plane. For example, if a signal is to be routed to the sixth NGSO satellite 105 in the orbital plane (e.g., NGSO satellite 105-6), the destination tag can be the digital value ‘110’. The router 310 in each NGSO satellite 105 knows its own index and either the indices of its adjacent NGSO satellites 105 or whether to route to a next NGSO satellite 105 ahead or behind in the orbital plane to reach the indicated index. The same technique can be used for ISL routing in the forward and return communication directions.

Other embodiments can implement the destination tag as a 3-bit tag (N=3), where two of the bits represent a hop counter, and the third bit is a directional indicator. Two bits are used for the hop counter portion of the destination tag based on an assumption that there is a maximum of three hops needed for global coverage. The number of bits used for hop counting can be adjusted to accommodate different maximum numbers of hops. As a first example, if a forward uplink signal is transmitted to NGSO satellite 105-1 and is destined for NGSO satellite 105-4 (i.e., three hops in an ahead direction), the destination tag may represent this as ‘111’: one bit (e.g., the most-significant or least-significant bit) is ‘1’ to represent the ahead direction, and the other two bits are ‘11’ to represent three hops. As a second example, if a forward uplink signal is transmitted to NGSO satellite 105-1 and is destined for NGSO satellite 105-6 (i.e., two hops in a behind direction), the destination tag may represent this as ‘010’: one bit is ‘0’ to represent the behind direction, and the other two bits are ‘10’ to represent two hops. In such embodiments, the router 310 can use the destination tag as a counter. In the second example, the router 310 of NGSO satellite 105-1 receives the destination tag as ‘010’ and transmits it to NGSO satellite 105-7 as ‘001’ (i.e., the directional bit remains ‘0’, and the hop counter bits decrement from ‘10’ to ‘01’). When the destination tag is received by the router 310 of NGSO satellite 105-7, the destination tag now represents that there is an additional hop needed in the behind direction. Now, the router 310 of NGSO satellite 105-7 can transmit the destination tag to NGSO satellite 105-6 as ‘000’ (i.e., the directional bit remains ‘0’, and the hop counter bits decrement from ‘01’ to ‘00’). When the destination tag is received by the router 310 of NGSO satellite 105-6, the destination tag now represents that the present NGSO satellite 105 (i.e., NGSO satellite 105-6) is the destination NGSO satellite 105, and its router 310 can route the signal to its UL system 225 for transmission via its user downlink. The same technique can be used for ISL routing in the forward and return communication directions.

Other embodiments can implement the destination tag as an N-bit tag, where there are X NGSO satellites 105 in the orbital plane, and N is the closest integer greater than log₂(X−1). Such embodiments assume that ISL routing only operates in only one direction (i.e., either in an ahead direction or in a behind direction, but not both), and the N-bit tag is effectively a hop counter with a maximum of X−1 hops. For example, if a forward uplink signal is transmitted to NGSO satellite 105-1 and is destined for NGSO satellite 105-4, the destination tag may indicate ‘011’ (i.e., three hops); if a forward uplink signal is transmitted to NGSO satellite 105-1 and is destined for NGSO satellite 105-7, the destination tag may indicate ‘110’ (i.e., six hops).

In some embodiments, ISL routing approaches, including implementations of the destination tag, are designed to operate even when certain ISLs cannot be used. For example, embodiments can adapt ISL routing to accommodate for a failure of one or more ISLs and/or feeder links along the primary routing path, and/or for cases in which a segment of the ISL path is preempted (e.g., for traffic between a failed GW-RU and a backup GW-RU). In some embodiments, an alternate routing is automatically determined and/or selected (e.g., from a list of predetermined options) by the NodeB 120. In other embodiments, the NOC 130 determines (or selects) and activates an alternative routing in response to such conditions. In some embodiments, forward-link and return-link 5G NR processing is performed in pairs, imposing a requirement that ISL routings are symmetric and processed in the same GW-RU 125, accordingly. In other embodiments, the NOC 130 can determine (or select) and activate an alternative ISL routing for only one direction (e.g., when equipment failure is limited to one direction).

As described herein, components of the NGSO satellite 105, such as components of the architecture 300 of FIG. 3, can be implemented wholly or partially by one or more processors. In particular, the one or more processors can perform on-board routing features described herein. For example, analog feeder uplink communications are received via the FL system 205 from a currently active GW-RU 125, user uplink communications are received via the UL system 225 via return user beams, and inbound ISL signals are received via the ISL system 320 from one or more other satellites of a same constellation (e.g., in a same orbital plane). In some embodiments, the one or more processors can determine whether each analog feeder uplink communication is one of a set of forward relay signals or one of a set of ISL forwarding signals, whether each user uplink communication is one of a set of return relay signals or one of the set of ISL forwarding signals, and whether each inbound ISL signal is one of the set of forward relay signals, one of the set of return relay signals, or one of the set of ISL forwarding signals. The one or more processors can then route the set of forward relay signals to the UL system 225 for transmission as user downlink communications, route the set of return relay signals to the FL system 205 for transmission as feeder downlink communications, and route the set of ISL forwarding signals to the ISL system 320 for transmission as outbound ISL signals. In some embodiments, the one or more processors can further: for each feeder uplink communication determined to be one of the set of ISL forwarding signals, convert the feeder uplink communication to a digital signal prior to transmission via the ISL system 320; and for each inbound ISL signal determined to be one of the set of return relay signals, convert the inbound ISL signal to an analog signal prior to transmission by the FL system 205. In some embodiments, each feeder and user uplink communication is received as an analog subchannel signal, and the one or more processors can further: for each user uplink communication determined to be one of the set of ISL forwarding signals, convert the feeder uplink communication to a digital signal prior to transmission via the ISL system 320; and for each inbound ISL signal determined to be one of the set of forward relay signals, convert the inbound ISL signal to an analog signal prior to transmission by the UL system 225.

In some embodiments, all the on-board routing features are performed by the router 310, such that the router 310 includes the one of the one or more processors. In other embodiments, performance of the on-board routing is distributed among two or more of the FL system 205, the UL system 225, the ISL system 320, the control system 245, and the router 310. For example, the FL system 205 includes a first portion of the one or more processors to determine whether each analog feeder uplink communication is either a forward relay signal or an ISL forwarding signal, and either to route the forward relay signal directly to the UL system 225 for transmission, or to route the ISL forwarding signal to the router 310; the UL system 225 includes a second portion of the one or more processors to determine whether each user uplink communication is either a return relay signal or an ISL forwarding signal, and either to route the return relay signal directly to the FL system 205 for transmission, or to route the ISL forwarding signal to the router 310; and the router includes a third portion of the one or more processors to determine whether each inbound ISL signal is a forward relay signal, a return relay signal, or an ISL forwarding signal, and either to route the forward relay signal to the UL system 225 for transmission, to route the return relay signal to the FL system 205 for transmission, or to route ISL forwarding signal to the ISL system 320 for transmission.

Modern terrestrial wireless communication systems tend to allocate network resources (e.g., bandwidth) to user devices 140 based on a fundamental unit, referred to as a resource block (RB). According to 4G/LTE, 5G NR, and other standard and protocols, each RB is essentially a fundamental unit of radio resource allocation within the time and frequency domain, as enabled by the OFDMA downlink (i.e., forward) modulation scheme. In the frequency domain, each RB corresponds to a chunk of available bandwidth (e.g., typically a contiguous set of sub-carriers, a subchannel, etc.). The term “subchannel” is used herein to avoid potential confusion with 5G “sub-carriers.” The number of subchannels in each RB can depend on channel bandwidth, subcarrier spacing, and/or other factors. Many 5G NR deployments use 5 MHz RBs, but other suitable frequency dimensions can be used (e.g., 10 MHz, 20 MHz, etc.). In the time domain, each RB corresponds to a duration of time. For example, 5G NR defines a time-frequency grid made up of frames, which are divided into sub-frames, which are further divided into slots. Typically, the sub-frame duration and the number of slots per sub-frame defines the slot duration, which effectively defines the time duration of each RB. In essence, use of RBs allows the network to allocate network resources in a dynamic manner that is flexible in both the time and frequency dimensions. For example, allocation of RBs can be dynamically adjusted to account for dynamic changes in traffic conditions and/or other conditions impacting supply and demand of network resources.

Embodiments described herein adopt the concept of RBs at least to facilitate compatibility between the novel types of NTN architectures described herein and user devices 140 that are configured to operate with cellular communication infrastructures, such as 4G/LTE and 5G NR. Though the term “RB” is used in context of embodiments herein, the term is not intended to be restricted to the types of RBs available in 4G/LTE and 5G, or even to OFDM modulation contexts; rather, the term is intended broadly to include any suitable type of network resource allocation that is compatible with the standards and protocols of a terrestrial communication infrastructure being extended for the type of satellite-based NTN infrastructure described herein.

FIGS. 4A and 4B show two illustrative feeder-link frequency plans 400 for use with transparent satellite-based NTN infrastructures, according to embodiments described herein. As described above, embodiments of the NTN architecture seek to interface with user devices 140 using their existing capability to interface with cellular networks. As such, it is desirable to architect the network so that the user downlink signals (i.e., to be sent from the satellite 105 to the user devices 140) correspond to allocated RBs, in accordance with whatever cellular network standards and protocols are supported by the user devices 140. For example, it may be desirable to architect the network so that the satellite is transmitting 5 MHz signals on the forward user beams (i.e., on the user downlinks) in accordance with 5 MHz RBs as supported by 5G NR.

Also as described above, because of the transparent nature of the satellite architecture, the formatting of the feeder uplink signals by the ground-based NodeB 120 determines the type of user downlink signals that will be sent back down to the user devices 140 (i.e., the satellite is essentially a bent-pipe relay without any additional waveform processing on-board). As such, embodiments of the NTN architecture are designed so that the ground-based NodeB 120 formats the feeder link waveforms to provide the desired user link waveforms. In particular, embodiments segment the feeder-link carrier into subchannels, each having a frequency dimension corresponding to an RB allocation (e.g., 5 MHz). Forward and return DtD signals are assigned to respective ones of the subchannels.

Each of the feeder-link subchannels is referred to herein as a resource block channel (RBC). Each RBC can be an uplink RBC (URBC 415, corresponding to a subchannel, or RB allocation, of the forward uplink 410) or a downlink RBC (DRBC 435, corresponding to a subchannel, or RB allocation, of the forward downlink 430). As illustrated in FIGS. 4A and 4B, there can be N URBCs 415 and M DRBCs 435, where N and M are positive integers. In some implementations, N and M are the same. In one implementation, the feeder uplink 410 uses one carrier (e.g., one frequency range) and the feeder downlink 430 uses a different carrier. In another implementation, the feeder uplink 410 uses one polarization orientation (e.g., right-hand circular polarization, RHCP), and the feeder downlink 430 uses an orthogonal polarization orientation (e.g., left-hand circular polarization, LHCP). In another implementation, interference between the feeder uplink 410 and the feeder downlink 430 is mitigated using time-division and/or other techniques. Each forward DtD signal (i.e., not the control signals) can be assigned to a respective URBC 415, and each return DtD signal can be assigned to a respective DRBC 435. As such, in some embodiments, each forward user beam to be formed by the UL system 225 of a NGSO satellite 105 corresponds to a respective URBC 415, and each return user beam to be formed by the UL system 225 of the NGSO satellite 105 corresponds to a respective DRBC 435. The URBCs 415 and the DRBCs 435 can also be separated by a subchannel spacing (e.g., 0.5 MHz, 1 MHz, 3 MHz, etc.).

A portion of the feeder uplink 410 bandwidth can also be allocated to a control channel (CC) 420 for carrying the control signal. The control signal is used only by the satellite 105, and therefore it is unnecessary to match the CC 420 dimension to that of an RB (i.e., the frequency dimension of the CC 420 can be the same as, greater than, or smaller than that of the RBCs). In some implementations, each RBC corresponds to a respective 5 MHz subchannel, the CC 420 corresponds to a respective 15 MHz subchannel. In one such implementation, the carrier spacing between all subchannels is 0.5 MHz; the feeder uplink 410 is segmented into 160 URBCs 415 (i.e., N=160) and one CC 420, occupying 895 MHz (i.e., [(5+0.5)*160)]+15); and the feeder downlink is segmented into 160 DRBCs 435 (i.e., M=160) with no CC 420, occupying 880 MHz (i.e., (5+0.5)*160). In a second such implementation, the feeder uplink 410 includes two orthogonal polarization orientations, RHCP and LHCP. In the LHCP portion, the feeder uplink 410 is segmented into 96 URBCs 415, including three sets of 32 URBCs 415, wherein each of the URBCs 415 within each set is separated from its neighboring URBC(s) 415 by a 1-MHz carrier spacing, and each of the three sets is separated from its neighbor(s) by a 3 MHz carrier spacing, thereby occupying 579 MHz (i.e., 3*((32*5)+(31*1))+(2*3)=579). The RHCP portion of the feeder uplink 410 can also be segmented into 96 URBCs 415 (i.e., N=96+96=192) in the same manner with the addition of one CC 420 separated by another 3-MHz guard band, thereby occupying 597 MHz (i.e., 579+15+3). Thus, this second implementation can multiplex 192 URBCs 415 (i.e., N=96+96=192) into approximately 600 MHz of feeder uplink bandwidth. According to such frequency plans 400, the NodeB 120 (e.g., and the GW-RU 125) format the feeder uplink and downlink waveforms on the ground into analog feeder-link waveforms carrying the DtD (e.g., 5G NR) waveforms as subchannels. Further, time-division techniques are used to assign DtD signals to appropriate RBCs in appropriate time slots to so that the correct DtD signals will be sent to the correct beam coverage areas at the correct times in coordination with the BHBF schema.

Each frequency plan 400 shows N URBCs 415-1-415-N and N DRBCs 435-1-435-N. In satellite architecture embodiments that support ISLs, such as architecture 300 of FIG. 3, a first portion of the URBCs 415 and a second portion of the DRBCs 435 can be allocated to relay channels that will be relayed through the satellite between the FL system 205 and the UL system 225 (e.g., directly or through the router 310), and a third portion of the URBCs 415 and a fourth portion of the DRBCs 435 can be allocated to ISL channels for routing at the satellite to or from corresponding ISLs (via the router 310). In some embodiments, the first and second portions are the same (i.e., the same number of URBCs 415 and DRBCs 435 is allocated to relay channels), and the third and fourth portions are the same (i.e., the same number of URBCs 415 and DRBCs 435 is allocated to ISL channels). In other embodiments, some or all of the different portions can have different numbers of RBCs.

In some embodiments, the allocations of RBCs to relay channels and ISL channels are flexible. Turning to FIG. 4A, a first frequency plan 400a shows all of the RBC as agnostic to whether they are assigned to relay channels or ISL channels. In such embodiments, the control signal sent over the CC 420 can tell the router 310 at the satellite 105 which of the RBCs are carrying signals for routing to or from the ISLs, and which of the RBCs are carrying signals for routing to or from the UL system 225. Such a configuration enables flexible assignment of relay and ISL channels, such as to account for dynamic changes in demand for such channels. For example, a particular satellite 105 may tend to have more need for ISL channels in timeframes when traversing certain portions of its orbital path, and less need otherwise, so that it can be desirable to allocate a larger portion of the RBCs to ISL channels in those timeframes.

In other embodiments, the allocations of RBCs to relay channels and ISL channels are fixed (e.g., there is a rigid boundary). Turning to FIG. 4B, a second frequency plan 400b shows the RBC as divided into “Relay” and “ISL” channels. As illustrated, the N URBCs 415 are divided into a first portion (URBCs 415-1-415-J) for relay channels and a second portion (URBCs 415-J+1-415-N) for ISL channels, and the M DRBCs 435 are divided into a third portion (DRBCs 435-1-435-K) for relay channels and a fourth portion (DRBCs 435-K+1-435-M) for ISL channels. In some embodiments, J and K are equal, such that the same number of RBCs is allocated to relay channels in the forward and return directions. In some embodiments, M and N are also equal, such that the same number of RBCs is allocated to ISL channels in the forward and return directions. Such an approach can simplify routing at the satellite at the expense of reduced flexibility in allocating relay and ISL channels.

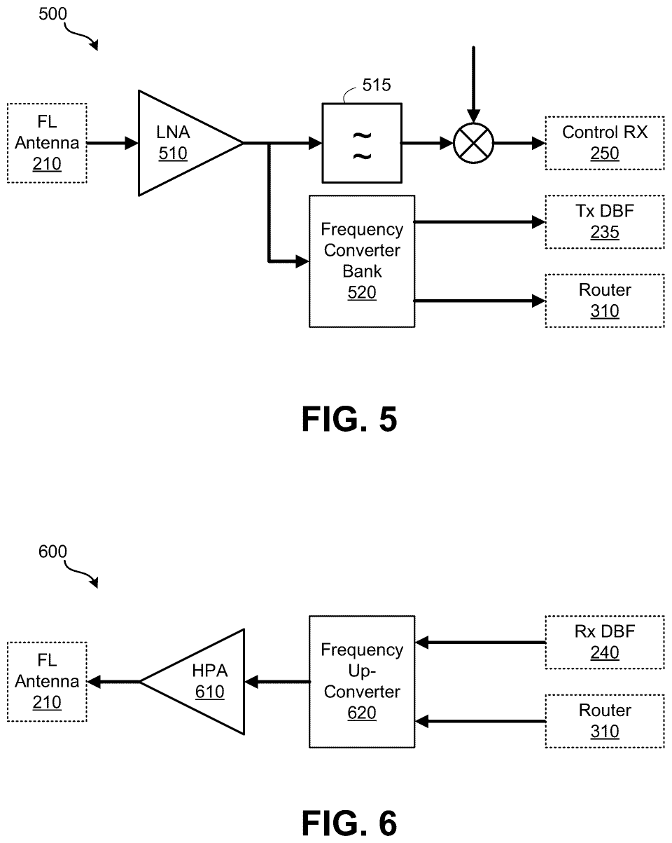

In either frequency plan 400, a single feeder uplink 410 effectively multiplexes N forward DtD signals on respective URBCs 415 of an analog uplink waveform and effectively multiplexes M return DtD signals on respective DRBCs 435 of an analog downlink waveform. FIGS. 5 and 6 shows example implementations of FL system 205 components at the satellite 105 to support communication of those feeder-link waveforms.

According to some embodiments, either frequency plan 400 can provide a relatively flexible approach by leaving the mapping between ISL channel numbers, NGSO satellite 105 numbers (in the orbital plane), and a beam number for that NGSO satellite 105 to be determined by the control information sent on the feeder uplink (via CC 420). In some such embodiments, such a flexible mapping enables dynamic allocation of traffic and/or bandwidth to beams. For example, traffic over the ocean may be relatively light for individual beams, such that the traffic only fills a portion of the RBC capacity for each beam. In such cases, the actual transmit bandwidth can be compressed to accommodate more beams per satellite. Other embodiments can implement a more rigid fixed mapping assignment, which can further simplify the router 310 operation at the expense of flexibility and related features.

As described herein, when an NGSO satellite 105 serving a landmass loses its feeder-link connection to its GW-RU 125, it can use another NGSO satellite 105 in the same orbital plane that has a functional feeder-link (i.e., an “assisting feeder link”) to a GW-RU 125 to maintain its connectivity via ISL communications. However, this may only be effective if the ISL and the assisting feeder link both sufficient capacity to accommodate the additional traffic from the failed feeder link. If the capacity is not sufficient, embodiments can split the traffic and can use two or more NGSO satellites 105 on the same orbital plane, and their corresponding operational feeder links, to back up the NGSO satellite 105 suffering a feeder-link outage. In such cases, multiple ISLs are concurrently used. For example, the NOC 130 can determine to split the traffic from the failed feeder link into two halves, to send each half through a respective assisting feeder link to a respective other two NGSO satellites 105 in the orbital plane, and to concurrently use two ISLs associated with those other two NGSO satellites 105.

In some instances, although the ISL(s) and feeder link(s) may have sufficient capacity to accommodate the traffic from the failed feeder link at certain times, the capacity of those links can change over time. For example, at the time of a GW-RU 125 outage, some ISL(s) and/or feeder link(s) may also have traffic from NGSO satellites 105 serving oceans without GW-RU connections, and the aggregation of all that additional traffic may exceed the capacity of the feeder link(s) and/or ISL(s). In such cases, some embodiments preempt lower priority traffic with higher priority traffic. For example, at least a portion of the ocean can be preempted for any higher priority traffic caused by the feeder-link outage. Because the NOC 130 has at least current NGSO satellite 105 locations, GW-RU 125 locations, and present traffic loading information for all the ISL(s) and feeder link(s), the NOC 130 can make determinations (e.g., dynamically, periodically, scheduled, etc.) to select substituting GW-RU 125 feeder link(s) and the NGSO satellite(s) 105 connected to those feeder links, thereby facilitating any switchovers and capacity re-allocations.

FIG. 5 shows a simplified circuit block diagram of an illustrative implementation of a feeder-link receiver (FL Rx) 500. The FL Rx 500 of FIG. 5 can be an implementation of the FL Rx 215 of FIG. 3. As illustrated, the FL Rx 500 can include an LNA 510, a bandpass filter 515, and a frequency converter bank 520. The FL antenna 210, control Rx 250, Tx DBF 235, and router 310 of FIG. 3 are shown for context. In accordance with FIGS. 4A and 4B, an analog feeder uplink waveform is received via the FL antenna 210; the received waveform multiplexes forward DtD signals onto N URBCs 415 and a control signal onto a CC 420. The waveform can be received via the LNA 510 (e.g., to account for atmospheric attenuation, path loss, etc.). As illustrated, the amplified waveform is sent both to the bandpass filter 515 and the frequency converter bank 520. The bandpass filter 515 can effectively separate out the CC 420 to isolate the control signal, modulate the control signal as needed (represented generally by a summer node), and forward the control signal to the control Rx 250. For example, the control signal is modulated and received as a DVB-S2/S2X signal that is modulated and encoded according to a constant code modulation (CCM) mode. The frequency converter bank 520 can isolate and down-convert each of the URBCs 415, so that each can be sent as a corresponding user-link (e.g., S-band) waveform with a frequency dimension and user-link subchannel corresponding to an RB compatible with receipt by the user devices 140. In some embodiments, all user-link waveforms are sent to the router 310, and the router determines whether to rout the waveforms to the UL system 225 (i.e., to the Tx DBF 235) or to the ISL system 320. In other embodiments, as illustrated, an appropriate portion of the user-link waveforms is sent to the UL system 225 (i.e., to the Tx DBF 235), and the remaining portion of the user link waveforms is sent to the router 310 for routing to the ISL system 320.

FIG. 6 shows a simplified circuit block diagram of an illustrative implementation of a feeder-link transmitter (FL Tx) 600. The FL Tx 600 of FIG. 6 can be an implementation of the FL Tx 220 of FIG. 3. As illustrated, the FL Tx 600 can include an HPA 610 and a frequency up-converter 620. The FL antenna 210, Rx DBF 240, and router 310 of FIG. 3 are shown for context. In accordance with FIGS. 4A and 4B, an analog feeder downlink waveform is transmitted from the satellite via the FL antenna 210; the transmitted waveform multiplexes return DtD signals onto M DRBCs 435. Multiple user uplink signals are received as analog waveforms by the frequency up-converter 620. One portion of the signals is received from respective user uplink channels via the Rx DBF 240, and another portion of the signals is received from one or more ISLs via the router 310 (e.g., or both portions of the signals are received via the router 310). The frequency up-converter 620 frequency-converts each user-link signal to a respective subchannel of the feeder downlink 430 associated with an appropriate respective one of the DRBCs 435, thereby effectively multiplexing all the user-link signals onto the feeder downlink waveform. The feeder downlink waveform can then be amplified by the HPA 610 to account for atmospheric attenuation, path loss, and the like in the downlink path.

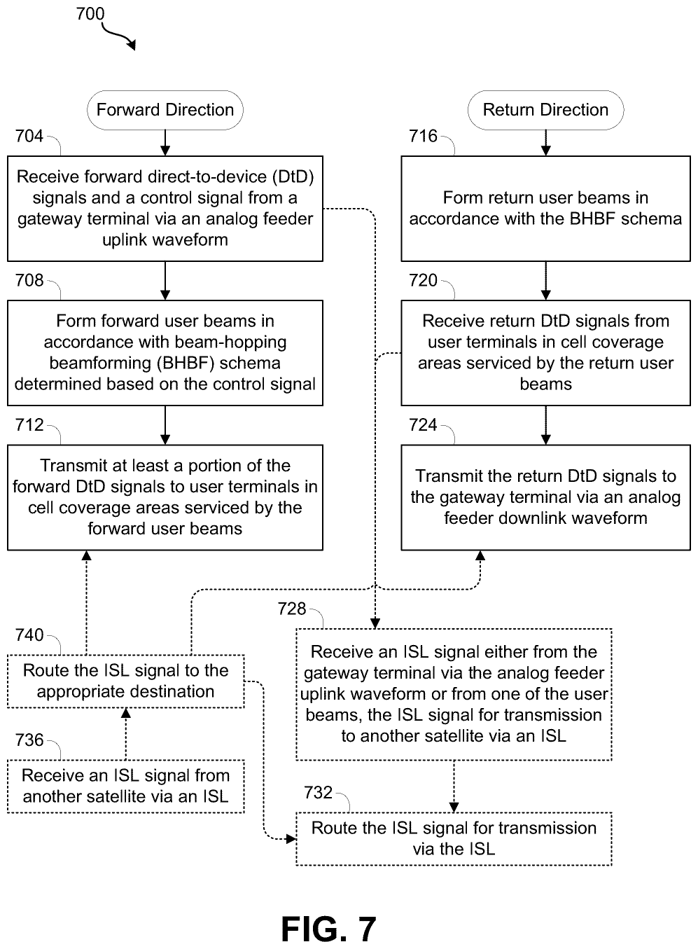

FIG. 7 shows a flow diagram of an illustrative method 700 for non-terrestrial network communications via a non-geosynchronous orbit (NGSO) satellite, according to various embodiments described herein. Embodiments of the method 700 include a “forward” communications portion and a “return” communications portion. The forward communications portion of the method 700 can begin at stage 704 by receiving (e.g., by the satellite from a GW-RU) forward direct-to-device (DtD) signals and a control signal via an analog feeder uplink waveform. At stage 708, embodiments can form forward user beams in accordance with beam-hopping beamforming (BHBF) schema determined based on the control signal. At stage 712, embodiments can transmit at least a portion of the forward DtD signals (i.e., the relay channel portion, and not the ISL channel portion) from the satellite to user terminals in cell coverage areas serviced by the forward user beams.

The return communications portion of the method 700 can begin at stage 716 by forming return user beams in accordance with the BHBF schema. A stage 720, embodiments can receive return DtD signals from user terminals in cell coverage areas serviced by the return user beams. At stage 724, embodiments can transmit the return DtD signals by the satellite to the GW-RU via an analog feeder downlink waveform.

In some embodiments, as described herein, the analog feeder uplink waveform is segmented into uplink resource block channels (URBCs). Each URBC can correspond to a respective subchannel of a feeder uplink, and each forward DtD signal can be received via a respective one of the URBCs. Similarly, the analog feeder downlink waveform is segmented into downlink resource block channels (DRBCs). Each DRBC can correspond to a respective subchannel of a feeder downlink, and each forward DtD signal can be received via a respective one of the URBCs. In some embodiments, each forward DTD signal and each return DtD signal is formatted for compatibility with a cellular networking protocol (e.g., as a OFDM signal formatted according to 5G NR protocols. In such embodiments, each URBC and each DRBC can have a frequency dimension corresponding to a resource block allocation defined by the cellular networking protocol. In some embodiments, the analog feeder uplink waveform is further segmented into a control channel corresponding to an associated subchannel of the feeder uplink separate from the URBCs, and the control signal is received via the control channel.

In some embodiments, the forward and/or return communications through the satellite further include inter-satellite link (ISL) communications with other satellites in a same constellation. For example, some embodiments, at stage 728, can receive an ISL signal by the satellite either from the GW-RU via the analog feeder uplink waveform or from one of the return user beams. The received ISL signal is for transmission to another satellite of constellation via an ISL. At stage 732, such embodiments can route the ISL signal for transmission to the other satellite via the ISL. Similarly, at stage 736, some embodiments can receive an ISL signal by the satellite from another satellite of the constellation via an ISL. At stage 740, such embodiments can route the ISL signal, as appropriate, either for transmission to the GW-RU via the analog feeder downlink waveform, to one or more user terminals via one of the forward user beams, or to yet another satellite of the constellation via another ISL. As described above, routing of the ISL signals and/or the DtD signals can be directed at least partially by routing information received via the control signal.

Use of transparent mode satellite architectures to facilitate NTN deployments provides several features. One feature is that access to equipment on the ground simplifies interworking of the NB-IoT and NTN NR waveforms, as well as future standards updating. This can help roll out such a deployment, such as when consumer handsets, or other user devices supporting NTN NR, may not initially be available in large quantities. Another similar feature is that the use of analog feeder links in satellite bands with no terrestrial wireless-type (e.g., 5G NR) processing on board the satellite (i.e., there is only beam forming and ISL routing on-board) tends to make the satellite design simpler and more robust. Another feature is that such approaches provide flexibility to scale capacity with more satellites or bandwidth as traffic demand increase in increments of the RBCs (e.g., in 5 MHz increments) per the terrestrial wireless protocols (e.g., in 5 MHz increments for 5G NR). Similarly, such an approach provides flexibility to improve coverage by adding additional GW-RUs as needed. Another feature is that the transparent nature of the DtD signal path means that the RBCs are agnostic to the types of waveforms being sent over them. For example, some of the RBCs can be used to carry 5G signals for consumer handsets, others can be used to carry IoT data for a wide variety of IoT devices, and others can be used to carry special waveforms to support proprietary uses by particular government and/or business customers.

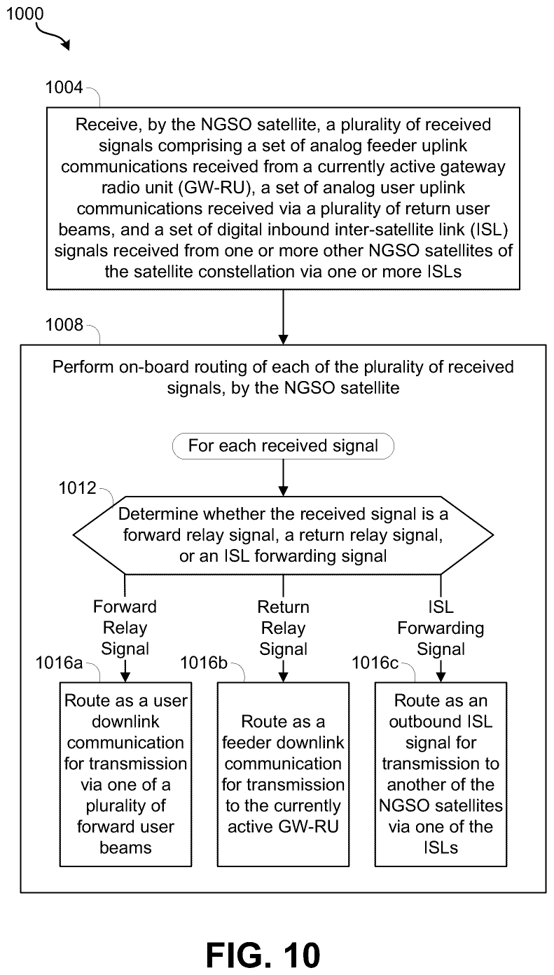

FIG. 10 shows a flow diagram of a method 1000 for on-board routing in a non-geosynchronous orbit (NGSO) satellite of a satellite constellation with analog feeder links, according to embodiments described herein. The method 1000 can be implemented using any suitable NGSO satellite architecture, such as the architecture 300 of FIG. 3. Embodiments of the method 1000 begin at stage 1004 by the NGSO satellite receiving received signals. The received signals include a set of analog feeder uplink communications received from a currently active gateway radio unit (GW-RU), a set of analog user uplink communications received via a plurality of return user beams, and a set of digital inbound inter-satellite link (ISL) signals received from one or more other NGSO satellites of the satellite constellation via one or more ISLs. At any particular time (e.g., a particular location in the orbital path, a particular time slot, etc.) the quantity of each type of received signal can be fixed or variable. The phrase “a set of” is intended to indicate that the NGSO satellite can accommodate concurrent receipt of one or more of each type of received signal, although a particular set may be a null set during one or more time slots and/or in one or more locations along the NGSO satellite's orbital path. For example, along the majority of an NGSO satellite's orbital path, the satellite may concurrently receive over one hundred feeder uplink communications, over one hundred user uplink communications, and tens of inbound ISL signals; however, while the NGSO satellite is over the ocean, the satellite may receive zero feeder uplink communications and the same or larger quantities of user uplink communications and/or inbound ISL signals.

At stage 1008, embodiments can perform on-board routing of each of the received signals by the NGSO satellite. The performance of on-board routing can involve iterating stages 1012 and 1016 for each received signal. At stage 1012, embodiments can determine whether the received signal is a forward relay signal, a return relay signal, or an ISL forwarding signal. For example, for each analog feeder uplink communication, stage 1012 can determine whether the feeder uplink communication is one of a set of forward relay signals or one of a set of ISL forwarding signals; for each analog user uplink communication, stage 1012 can determine whether the user uplink communication is one of a set of return relay signals or one of the set of ISL forwarding signals; and for each digital inbound ISL signal, stage 1012 can determine whether the inbound ISL signal is one of the set of forward relay signals, one of the set of return relay signals, or one of the set of ISL forwarding signals.

As illustrated, the method 1000 can perform a different version of stage 1016 depending on the result of the determination at stage 1012. Responsive to the received signal being determined at stage 1012 to be a forward relay signal, embodiments can route the received signal as a user downlink communication for transmission via one of several forward user beams at stage 1016a. Responsive to the received signal being determined at stage 1012 to be a return relay signal, embodiments can route the received signal as a feeder downlink communication for transmission to the currently active GW-RU at stage 1016b. Responsive to the received signal being determined at stage 1012 to be an ISL forwarding signals embodiments can route the received signal as an outbound ISL signal for transmission to another of the NGSO satellites of the satellite constellation via a corresponding one of the ISLs at stage 1016c.

In some embodiments, the routing at stage 1016 includes analog-to-digital and/or digital-to-analog conversion of signals, as appropriate. For example, some embodiments convert all analog signals (e.g., the feeder uplink communications and the user uplink communications) to digital signals prior to (or as part of) routing to the ISL system. For example, any time either a feeder uplink communication or a user uplink communication is determined at stage 1012 to be an ISL forwarding signal, the received signal is converted from an analog signal to a digital signal prior to (or as part of) routing at stage 1016c. Other embodiments convert all analog signals (e.g., the feeder uplink communications and the user uplink communications) to digital signals prior to (or as part of) all routing. Regardless of the determination at stage 1012, all feeder uplink communications and user uplink communications are converted from analog signals to digital signals prior to (or as part of) routing at any of stages 1016a, 1016b, or 1016c.

Further, digital signals can be converted to analog signals prior to routing at stage 1016a or 1016b. In some embodiments, any time the received signal is an inbound ISL signal that is determined at stage 1012 to be either a feeder uplink communication or a user uplink communication, the inbound ISL signal is converted to an analog signal prior to (or as part of) routing at stage 1016a or 1016b. In some embodiments that convert all feeder uplink communications and user uplink communications to digital signals, those signals can be converted back to analog signals prior to (or as part of) routing at stage 1016a or 1016b.

In some embodiments, the receiving at stage 1004 includes receiving the set of analog forward uplink communications each as a respective one of several resource block channels (RBCs) of a forward uplink carrier (i.e., as URBCs). As described herein, some URBCs can be relay RBCs that each carry traffic associated with a respective one of the forward user beams in each of number of time slots, and other URBCs can be ISL RBCs that each carry traffic associated with a respective one of the ISLs. In some implementations, the forward uplink carrier is segmented into N RBCs, including J relay URBCs and N-J ISL URBCs (N and J are positive integers). In some such implementations, J is fixed. For example, each URBC is pre-assigned as either a relay URBC or an ISL URBC. In other such implementations, J is variable. For example, the URBCs can be dynamically assigned as either relay URBCs or ISL URBCs (e.g., by the NOC) using control information sent to the NGSO satellite.

In some embodiments, the receiving at stage 1004 further includes concurrently receiving control information via a control channel of the forward uplink carrier. In such embodiments, the on-board routing is performed at stage 1008 at least partially based on the control information. In some such embodiments, the control information received via the control channel indicates which URBCs are assigned as relay URBCs or as ISL URBCs. As described herein, ISL forwarding signals can also include relevant portions of the control information (e.g., including a destination tag). As such, the receiving of inbound ISL signals at stage 1004 can include receiving associated control information; and the routing of outbound ISL signals at stage 1016c can be according to associated control information and can include routing the outbound ISL signals along with associated control information.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. Components of a larger system, wherein other rules may take precedence over or otherwise modify the application of the invention. Also, a number of steps may be undertaken before, during, or after the above elements are considered.

What is claimed is:

1. A non-geosynchronous orbit (NGSO) satellite of a satellite constellation, the NGSO satellite comprising:
a feeder link (FL) system to receive analog feeder uplink communications from a currently active gateway radio unit (GW-RU) and to transmit analog feeder downlink communications to the currently active GW-RU;
a user link (UL) system to form forward user beams and return user beams, to transmit user downlink communications via the forward user beams, and to receive user uplink communications via the return user beams;
an inter-satellite link (ISL) system to transmit outbound ISL signals to one or more other NGSO satellites of the satellite constellation via one or more ISLs and to receive inbound ISL signals from the one or more other NGSO satellites of the satellite constellation via the one or more ISLs; and
one or more processors configured to perform on-board routing by:
determining whether each analog feeder uplink communication is one of a set of forward relay signals or one of a set of ISL forwarding signals, whether each user uplink communication is one of a set of return relay signals or one of the set of ISL forwarding signals, and whether each inbound ISL signal is one of the set of forward relay signals, one of the set of return relay signals, or one of the set of ISL forwarding signals; and
routing the set of forward relay signals to the UL system for transmission as the user downlink communications, the set of return relay signals to the FL system for transmission as the feeder downlink communications, and the set of ISL forwarding signals to the ISL system for transmission as the outbound ISL signals.

2. The NGSO satellite of claim 1, further comprising:
a router coupled with the FL system, the UL system, and the ISL system, wherein the router comprises the one of the one or more processors to perform the on-board routing.

3. The NGSO satellite of claim 1, further comprising:
a router coupled with the FL system, the UL system, and the ISL system, wherein:
the FL system comprises a first portion of the one or more processors to determine whether each analog feeder uplink communication is one of a set of forward relay signals or one of a set of ISL forwarding signals, and either to route the one of the set of forward relay signals directly to the UL system for transmission, or to route the one of the set of ISL forwarding signals to the router;
the UL system comprises a second portion of the one or more processors to determine whether each user uplink communication is one of a set of return relay signals or one of the set of ISL forwarding signals, and either to route the one of the set of return relay signals directly to the FL system for transmission, or to route the one of the set of ISL forwarding signals to the router; and
the router comprises a third portion of the one or more processors to determine whether each inbound ISL signal is one of the set of forward relay signals, one of the set of return relay signals, or one of the set of ISL forwarding signals, and either to route the one of the set of forward relay signals to the UL system for transmission, to route the one of the set of return relay signals to the FL system for transmission, or to route the one of the set of ISL forwarding signals to the ISL system for transmission.

4. The NGSO satellite of claim 1, wherein the ISL system comprises:
one or more ISL antennas;
an ISL receiver to receive the inbound ISL signals via the one or more ISLs via the one or more ISL antennas; and
an ISL transmitter to transmit the ISL outbound signals via the one or more ISLs via the one or more ISL antennas.

5. The NGSO satellite of claim 1, wherein:
the feeder uplink communications and the inbound ISL signals comprise control information; and
the one or more processors perform the on-board routing according to the control information.

6. The NGSO satellite of claim 5, wherein, for each of the outbound ISL signals and for each of the inbound ISL signals:
the control information includes a respective destination tag; and
the one or more processors performs the on-board routing based on the respective destination tag.

7. The NGSO satellite of claim 6, wherein each of the outbound ISL signals and each of the inbound ISL signals is associated with a respective destination NGSO satellite of the satellite constellation, and its respective destination tag indicates a unique identifier of the respective destination NGSO satellite.

8. The NGSO satellite of claim 6, wherein each of the outbound ISL signals and each of the inbound ISL signals is associated with a respective destination NGSO satellite that is a number of hops away in the satellite constellation, and its respective destination tag indicates the number of hops.

9. The NGSO satellite of claim 1, wherein:
the satellite constellation comprises a plurality of NGSO satellites traversing a same orbital path in a same orbital plane; and
the ISL system comprises a first ISL antenna configured to communicate via a first ISL with a next NGSO satellite of the satellite constellation along the orbital path and a second ISL antenna configured to communicate via a second ISL with a previous NGSO satellite of the satellite constellation along the orbital path.

10. The NGSO satellite of claim 1, wherein:
the satellite constellation comprises a plurality of NGSO satellites traversing a same orbital path in a same orbital plane; and
the ISL system comprises only a single ISL antenna configured to communicate via a single ISL with one other NGSO satellite of the satellite constellation that is adjacent along the orbital path.

11. The NGSO satellite of claim 1, wherein the one or more processors is configured further to:
for each feeder uplink communication determined to be one of the set of ISL forwarding signals, convert the feeder uplink communication to a digital signal prior to transmission via the ISL system; and
for each inbound ISL signal determined to be one of the set of return relay signals, convert the inbound ISL signal to an analog signal prior to transmission by the FL system.

12. The NGSO satellite of claim 11, wherein:
each uplink communication is received as an analog subchannel signal; and
the one or more processors is configured further to:
for each user uplink communication determined to be one of the set of ISL forwarding signals, convert the feeder uplink communication to a digital signal prior to transmission via the ISL system; and
for each inbound ISL signal determined to be one of the set of forward relay signals, convert the inbound ISL signal to an analog signal prior to transmission by the UL system.

13. A method for on-board routing in a non-geosynchronous orbit (NGSO) satellite of a satellite constellation with analog feeder links, the method comprising:
receiving, by the NGSO satellite, a plurality of received signals comprising a set of analog feeder uplink communications received from a currently active gateway radio unit (GW-RU), a set of analog user uplink communications received via a plurality of return user beams, and a set of digital inbound inter-satellite link (ISL) signals received from one or more other NGSO satellites of the satellite constellation via one or more ISLs; and
performing on-board routing of each of the plurality of received signals, by the NGSO satellite, by:
determining whether the received signal is one of a set of forward relay signals, one of a set of return relay signals, or one of a set of ISL forwarding signals; and
routing the received signal as one of: a user downlink communication for transmission via one of a plurality of forward user beams responsive to determining that the received signal is one of the set of forward relay signals; a feeder downlink communication for transmission to the currently active GW-RU responsive to determining that the received signal is one of the set of return relay signals; or an outbound ISL signal for transmission to another of the NGSO satellites of the satellite constellation via a corresponding one of the ISLs responsive to determining that the received signal is one of the set of ISL forwarding signals.

14. The method of claim 13, wherein:
the receiving comprises receiving the set of analog forward uplink communications each as a respective one of a plurality of resource block channels (RBCs) of a forward uplink carrier; and
the plurality of RBCs comprises:
a plurality of relay RBCs, each to carry traffic associated with a respective one of the plurality of forward user beams in each of a plurality of time slots; and
one or more ISL RBCs, each to carry traffic associated with a respective one of the one or more ISLs.

15. The method of claim 14, wherein:
the forward uplink carrier comprises N RBCs, including J relay RBCs and N-J ISL RBCs; and
N and J are fixed-value positive integers.

16. The method of claim 14, wherein:
the receiving further comprises concurrently receiving control information via a control channel of the forward uplink carrier;
and the performing the on-board routing is at least partially based on the control information.

17. The method of claim 16, wherein the control information indicates which of the RBCs of the forward uplink carrier are relay RBCs and which are ISL RBCs.

18. The method of claim 16, wherein:
each of the ISL forwarding signals is associated with a portion of the control information that indicates a respective destination tag; and
for each of the ISL forwarding signals, the routing is based on the respective destination tag.

19. The method of claim 13, wherein the determining for each of the plurality of received signals comprises:
for each analog feeder uplink communication, determining whether the feeder uplink communication is one of a set of forward relay signals or one of a set of ISL forwarding signals;
for each analog user uplink communication, determining whether the user uplink communication is one of a set of return relay signals or one of the set of ISL forwarding signals; and
for each digital inbound ISL signal, determining whether the inbound ISL signal is one of the set of forward relay signals, one of the set of return relay signals, or one of the set of ISL forwarding signals.

20. The method of claim 13, wherein the routing for each of the plurality of received signals comprises:
applying analog-to-digital conversion to each of the set of analog feeder uplink communications and to each of the set of analog user uplink signals, such that each of the plurality of received signals is a respective digital signal of a plurality of digital signals;
for each of the plurality of received signals determined to be one of the set of forward relay signals, routing the respective digital signal to a user-link (UL) transmitter (Tx) and converting the respective digital signal by the UL Tx to an analog downlink subchannel signal for transmission via the one of the plurality of forward user beams;
for each of the plurality of received signals determined to by one of the set of return relay signals, routing the respective digital signal to a feeder-link (FL) Tx and converting the digital signal by the FL Tx to an analog downlink subchannel signal for transmission to the currently active GW-RU; and
for each of the plurality of received signals determined to be one of the set of ISL forwarding signals, routing the respective digital signal to an ISL system for communication as a digital outbound ISL signal via the corresponding one of the ISLs.
